(19) United States
(12) Patent Application Publication
(10) Pub. No.: US 2026/0044366 A1
(43) Pub. Date: Feb. 12, 2026

(54) DYNAMIC JOB ROUTING AND DATA CONSOLIDATION

(71) Applicant: Microsoft Technology Licensing, LLC, Redmond, WA (US)

(72) Inventors: Akshat BORDIA, Redmond, WA (US); Sumeet KHUSHALANI, Kenmore, WA (US); Arijit TARAFDAR, Sammamish, WA (US); Xuan CAO, Sammamish, WA (US); Kishore Raghavan CHALIPARAMBIL, Snoqualmie, WA (US)

(21) Appl. No.: 18/798,267

(22) Filed: Aug. 8, 2024

(51) Int. Cl. G06F 9/48; G06F 9/54

(52) U.S. Cl. CPC G06F 9/4856; G06F 9/4881; G06F 9/541

(57) ABSTRACT

Systems, methods, and computer readable storage media described herein for dynamically routing jobs to job service architectures and consolidating data. In an aspect, a job request associated with a user account is received. A migration status of the user account is determined to indicate the user account is migrating from a first job service architecture to a second job service architecture. A determination of whether or not the migration state is enabled is made. If the migration state is enabled, the job request is routed to the second job service architecture, causing the second job service architecture to schedule a corresponding job. If the migration state is not, the job request is routed to the first job service architecture, causing the first job service architecture to schedule the job. In a further aspect, the job request comprises a script and the job comprises a step to execute the script.

### BACKGROUND

In resource provider implementations, a resource provider provides access to resources to user accounts. Sometimes, a resource provider migrates user accounts from one service architecture to another. Depending on the number of accounts the provider provides services for, the time to migrate all accounts from one architecture to another can be lengthy. Furthermore, access to resources may be paused during migration.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein provide dynamic job routing and data consolidation. In particular, embodiments described herein relate to migrating user accounts from one job service architecture to another job service architecture. For example, a job router receives a first job request associated with a user account. The job router determines whether a migration status of the user account indicates the user account is migrating from a first job service architecture to a second job service architecture and a migration state is enabled. If the migration status does indicate the user account is migrating and a migration state is enabled, the job router routes the first job request to the second job service architecture and the first job request causes the second job service architecture to schedule a first job. Otherwise, the job router routes the first job request to the first job service architecture and the first job request causes the first job service architecture to schedule a first job.

In a further aspect, the job router receives a second job request associated with the user account subsequent to routing the first job request. The job router determines the migration state is disabled and the second job request corresponds to a second job. The job router routes the second job request to the first job service architecture and causes it to schedule the second job.

In a further aspect, a job data consolidator receives a first job record from the first job service architecture and a second job record from the second job service architecture. The job data consolidator processes the first and second job records to generate processed records. The job data consolidator stores the processed records as consolidated data in a job data datastore.

In a further aspect, the first job record corresponds to a previous job performed by the first job service architecture, the previous job comprising a first operation to modify data. The first job comprises a second operation to modify the data. The first job causes the second job service architecture to access the job data datastore to receive the first job record.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of an example system for dynamically routing job requests, in accordance with an example embodiment.

FIG. 2 shows a flowchart of a process for dynamically routing a job request, in accordance with an example embodiment.

FIG. 3A shows a sequence diagram that illustrates a process by which a job operation request is dynamically routed to a job service architecture within the example system of FIG. 1.

FIG. 3B shows a sequence diagram that illustrates a process by which a job operation request is dynamically routed to a job service architecture within the example system of FIG. 1.

FIG. 4 shows a flowchart of a process for routing a job request subsequent to a disabling of a migration state, in accordance with another example embodiment.

FIG. 5 shows a flowchart of a process for determining a migration status of a user account, in accordance with an example embodiment.

FIG. 6 shows a flowchart of a process for determining to dynamically route a job request, in accordance with an example embodiment.

FIG. 7 shows a block diagram of a system for consolidating job data, in accordance with another example embodiment.

FIG. 8 shows a flowchart of a process for consolidating job data, in accordance with an example embodiment.

FIG. 9 shows a flowchart of a process for receiving a job record, in accordance with another example embodiment.

FIG. 10 shows a flowchart of a process for utilizing consolidated data, in accordance with another example embodiment.

FIG. 11 shows a block diagram of a system for fulfilling a job report request, in accordance with an example embodiment.

FIG. 12 shows a flowchart of a process for fulfilling a job report request, in accordance with an example embodiment.

FIG. 13 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments of Dynamically Routing Jobs

Embodiments of the present disclosure relate to routing job requests in scenarios where a user account is migrated from one job service architecture to another. In embodiments, a job request is a request to perform a job in a compute architecture. A job is a series of steps that are run as a unit. In embodiments, steps of a job are run sequentially. Alternatively, one or more steps of a job are run in parallel with each other. In embodiments, a job is a (e.g., smallest) unit of work scheduled to run on a job service architecture. A step comprises a task (e.g., a packaged script or procedure with a set of inputs) or script (e.g., code). Types of jobs include, but are not limited to, agent jobs, server jobs, and container jobs. Agent jobs are jobs that are performed on a single computing device. Server jobs are jobs performed by a server or group of computing devices. Container jobs are jobs performed in a container hosted by a computing device. A container bundles an application and its associated files (e.g., configuration files, libraries, and dependencies) (e.g., in a single image or folder). In an embodiment, a container is deployable across a variety of environments. In accordance with an embodiment, jobs are arranged in a pipeline. A pipeline is an (e.g., continuous) integration and deployment process for an application/service. In an embodiment, a pipeline defines how test, build, and deployment steps are run.

A job service architecture is computing devices and accompanying software configured to perform job requests for a user account. In some embodiments, a job service architecture runs many jobs daily (e.g., thousands, tens of thousands, hundreds of thousands, millions, and even greater numbers of jobs) across multiple user accounts (e.g., tens, hundreds, thousands, and even greater numbers of user accounts). As technology related to job performance changes, a resource provider makes changes to an existing job service architecture and/or implements a new job service architecture for use by the user accounts. For instance, a resource provider may desire migrating user accounts to a job service architecture that has improved security, that satisfies compliance requirements, that utilizes improved software and/or hardware, that operates in at a higher efficiency, that operates at a higher performance capability, that reduces cost (e.g., monetary or in compute resources) to run and/or maintain, and/or that is otherwise different from the job service architecture utilized by the user accounts. However, depending on the type of migration required, the time to migrate user accounts can be lengthy, could potentially introduce bugs or other operating errors, and/or otherwise impacts utilization of job services by the user accounts.

Embodiments of the present disclosure implement techniques for dynamically routing jobs between a “source” architecture and a “target” architecture. In this context, a source architecture is the architecture that a user account is currently utilizing (also referred to as a “legacy architecture” herein) and a target architecture is the architecture user account is being migrated to (also referred to as a “new architecture” herein). In an example embodiment, a job router receives a job request associated with a user account and determines a migration status of the user account. The migration status indicates whether or not the user account is being migrated from one architecture to another. The job router routes the job request to the job service depending on the migration status, thereby causing the job to be scheduled by the corresponding job service. In embodiments, a resource provider system is able to toggle the migration status of the user account, thereby changing which job service architecture the job router routes new jobs to. By dynamically routing jobs in this manner, embodiments of job routers allow a resource provider to (e.g., seamlessly) modify or troubleshoot a target architecture with little to no impact on a user account's usage of job services to perform jobs.

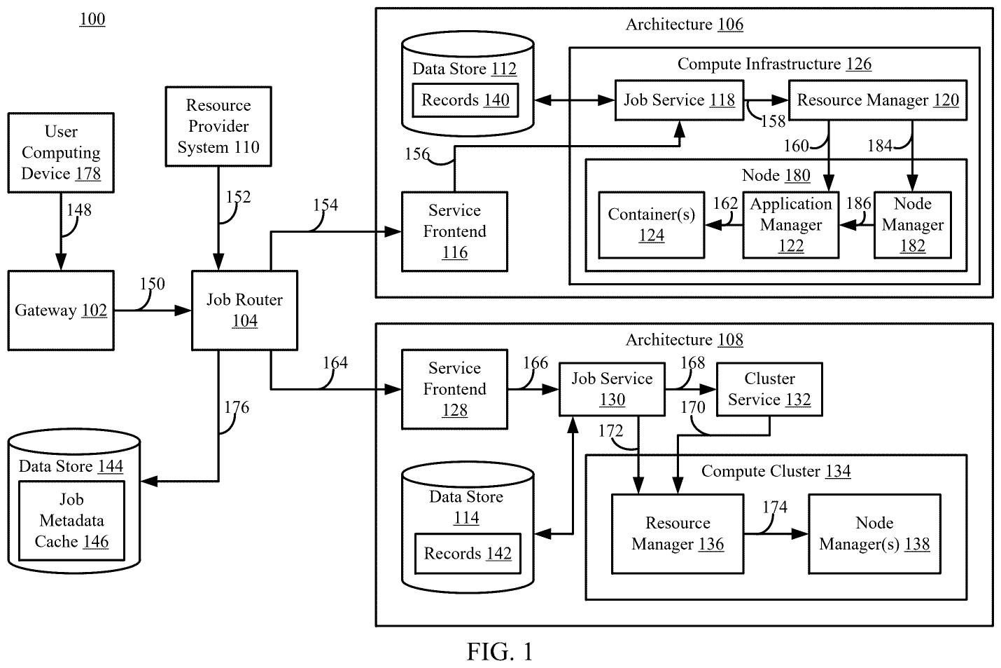

Embodiments of systems for dynamically routing jobs are configured in various ways. For example, FIG. 1 shows a block diagram of an example system 100 (“system 100” herein) for dynamically routing job requests, in accordance with an example embodiment. As shown in FIG. 1, system 100 comprises a gateway 102, a job router 104, a job service architecture 106 (“architecture 106” herein), a job service architecture 108 (“architecture 108” herein), a resource provider system 110, a data store 144, and a user computing device 178. In an implementation, gateway 102 and job router 104 are implemented in one or more computing devices, servers, virtual machines, and/or the like. In accordance with an embodiment, gateway 102 and job router 104 are implemented as a single device. Architectures 106 and 108 are different types of job service architectures configured to execute services and actions with respect to services based on received job service requests. Each of architectures 106 and 108 are implemented on one or more servers or other computing devices. In accordance with an embodiment, architecture 106 and/or architecture 108 are implemented in a cloud-based environment. In accordance with an embodiment, each of gateway 102, job router 104, job service architectures 106 and/or 108, resource provider system 110, data store 144, and/or user computing device 178 are communicatively coupled via one or more networks, not shown in FIG. 1 for brevity. Examples of such networks include, but are not limited to, local area networks (LANs), wide area networks (WANs), enterprise networks, the Internet, etc. In examples, the any of the networks include one or more wired and/or wireless portions. The features of system 100 are described in detail as follows.

Data store 144 is configured to store data utilized by and/or generated by user computing device 178, gateway 102, resource provider system 110, and/or job router 104. For instance, as shown in FIG. 1, data store 144 comprises a job metadata cache 146. Job metadata cache 146 comprises metadata of jobs submitted to and/or routed by job router 104. Examples of metadata of jobs includes, but are not limited to, job identifiers that uniquely identify the jobs, which architecture the job was routed to, a user account that requested the job, a time the job was requested, a time the job was routed to an architecture, a time the job was completed, and/or any other metadata associated with jobs routed to architectures 106 and/or 108 via job router 104.

In examples, user computing device 178 (also referred to as “computing device 178”) is any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. In accordance with an embodiment, computing device 178 is associated with a user (e.g., an individual user, a group of users, an organization, a family user, a customer user, an employee user, an admin user (e.g., a service team user, a developer user, a management user, etc.), etc.). Computing device 178 is configured to execute applications, in some embodiments. For instance, in accordance with an embodiment, computing device 178 is configured to execute an application to submit a user input 148 to gateway 102. User input 148 includes, in embodiments, a job ID of the job, a detail of one or more tasks to be performed as part of the job, data to be accessed by the job, a permission level required to perform the job, an application ID of an application or other service configured to and/or selected to perform the job, and/or any other details or other information regarding the job to be performed with respect to a user's account. In some embodiments, user input 148 is referred to as a “job request” or a “user-submitted job request”. In accordance with an embodiment, computing device 178 generates user input 148 responsive to user interaction with a user interface of computing device 178 (not shown in FIG. 1). Alternatively, computing device 178 automatically generates a request (e.g., in lieu of user input 148) for a job to be performed (e.g., based on a configuration of computing device 178 or an application executing on computing device 178).

Gateway 102 is configured to receive user input 148 (or another type of request) from computing device 178. Gateway 102 analyzes and/or otherwise processes user input 148, in an embodiment. For instance, gateway 102 in some implementations includes an authentication service that determines whether or not the user is authorized to submit a job request to system 100. As illustrated in FIG. 1, gateway 102 transmits a job request 150 to job router 104.

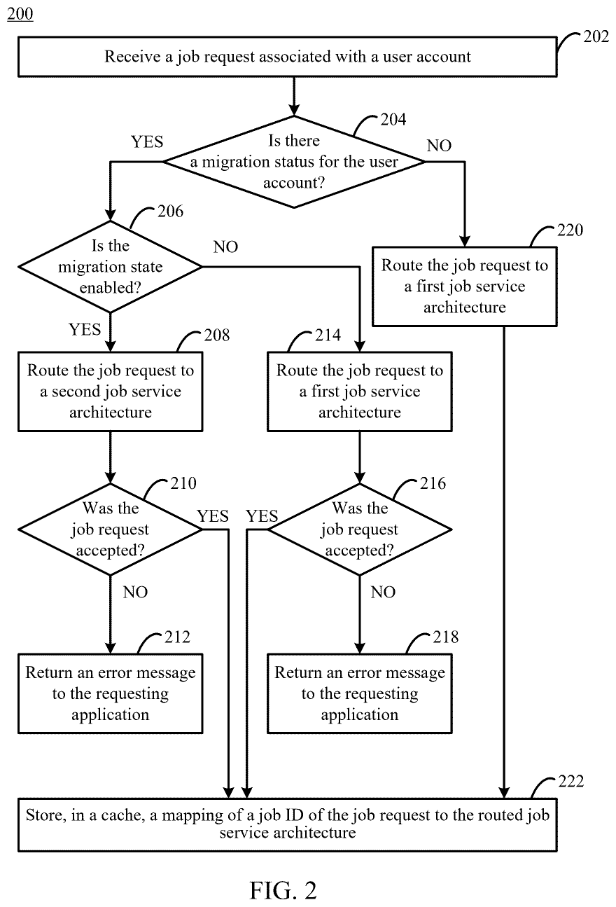

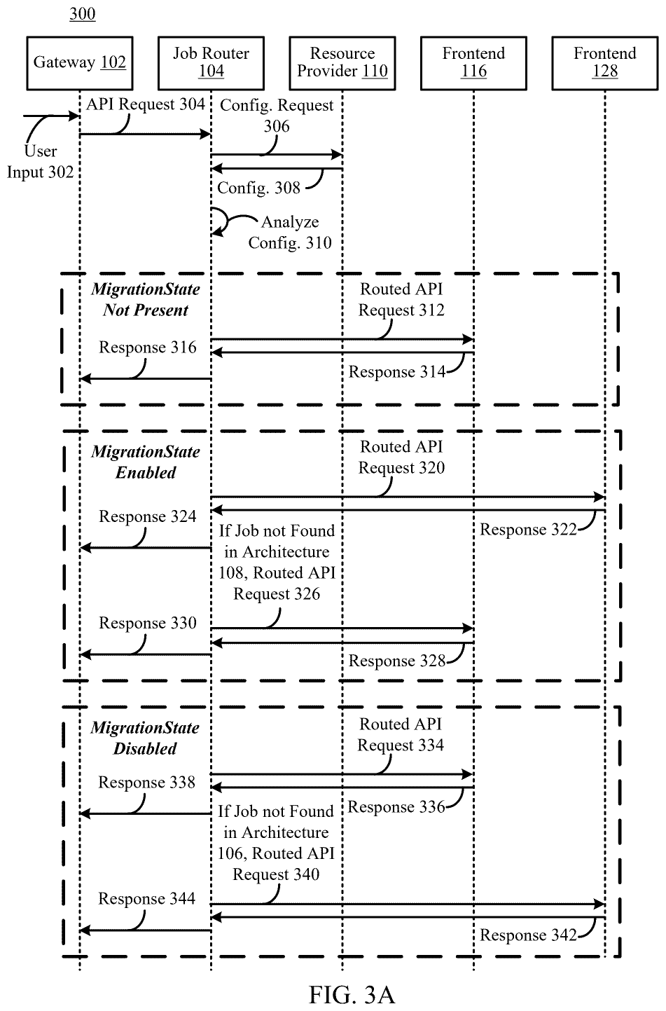

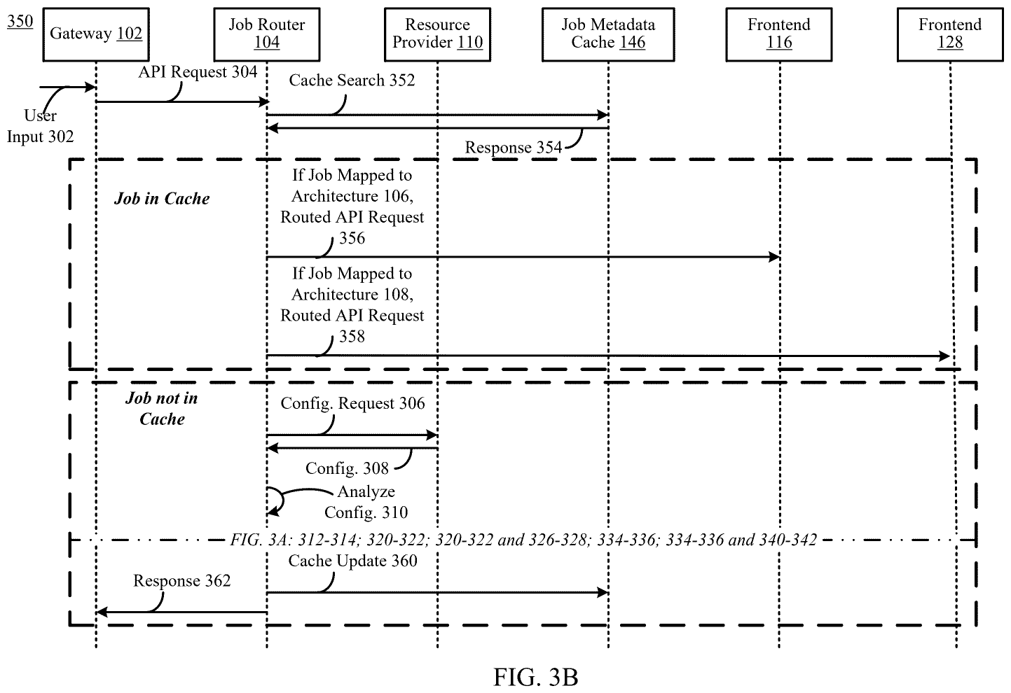

Job router 104 is configured to receive and process job request 150. For instance, in an implementation, job router 104 receives account configuration data 152 from resource provider system 110 for the user account associated with job request 150 and determines whether or not the user account is being migrated from one architecture (e.g., architecture 106) to another (e.g., architecture 108). Based on account configuration data 152 (and, in some embodiments, job metadata cache 146), job router 104 routes job request 150 to architecture 106 or architecture 108 via routed job request 154 or 164, respectively. In embodiments, routed job requests 154 and/or 164 comprise any information included in job request 154, account configuration data 154, included in job metadata cache 146 obtained by job router 104, and/or generated by job router 104. In some embodiments, job router 104 is configurable to interface with any kind of backend system (e.g., architecture 106 or architecture 108) without impacting the front-end user experience (e.g., the user experience in computing device 178). In some embodiments, subsequent to routing a job request to architecture 106 or architecture 108, job router 104 updates job metadata cache 146 with job routing data 176. In this context, job routing data 176 includes a job ID of the routed job request and an identifier of the architecture the job request was successfully routed to. Further details regarding routing of job requests are described with respect to FIGS. 2 and 3, as well as elsewhere herein.

Resource provider system 110 is configured to manage architecture 106, manage architecture 108, specify migration status of user accounts, maintain migration data, initiate operations with respect to migration, termination migration, and/or the like. In accordance with an embodiment, resource provider system 110 is implemented by one or more computing devices. In accordance with an embodiment, resource provider system 110 is a system of a cloud service provider (CSP) that provides access to cloud resources to users (e.g., customers) (e.g., the user of user computing device 178). In implementations, resource provider system 110 generates, manages, and/or stores account configuration data for user accounts that have access to resources of architecture 106 and 108.

Architecture 106 and 108 are different types of job service architectures configured to execute services and actions with respect to services based on received job service requests. As shown in FIG. 1, architecture 106 comprises a data store 112, a service frontend 116, and a compute infrastructure 126 (comprising a job service 118, a resource manager 120, and a node 180 (comprising a node manager 182, an application manager 122, and one or more containers 124 (“containers 124” herein))) and architecture 108 comprises a data store 114, a service frontend 128, a job service 130, a cluster service 132, and a compute cluster 134 (comprising a resource manager 136 and one or more node managers 138 (“node managers 138” herein)). While compute infrastructure 126 is depicted in FIG. 1 as comprising a single node 180, embodiments of the present disclosure include any number of nodes (e.g., ones, tens, hundreds, thousands, millions, or even greater numbers of nodes).

Data stores 112 and 114 are configured to store data utilized by and/or generated by respective architectures 106 and 108. As shown in FIG. 1, data store 112 stores records 140 (also referred to as “job records 140”) and data store 114 stores records 142 (also referred to as “job records” 142). Job records 140 and 142 comprise records of jobs executed by, executing on, and/or scheduled to be executed by components of respective architectures 106 and 108. A job record includes information regarding a job including, but not limited to, a job identifier (ID) that uniquely identifies the job, a task or workload to be performed, data to be accessed by the job, an application ID that uniquely identifies the application that requested the job (e.g., an application executing on user computing device 178, not shown in FIG. 1), a deadline to complete the job by, a user account ID (also referred to as a “user ID” or “account ID”) that uniquely identifies a user account associated with the job to be performed (e.g., a user account of the user associated with user computing device 178), and/or any other information pertaining to the job that was performed, is being executed, and/or is scheduled to be executed. As shown in FIG. 1, data store 112 and data store 114 are incorporated in architectures 106 and 108; however, embodiments described herein are not so limited. For instance, in an alternative embodiment, data store 112 and/or data store 114 are external to their respective architectures. In another embodiment, data stores 112 and 114 are the same data store. In another embodiment, data store 112 is incorporated in compute infrastructure 126. In another embodiment, data store 114 is incorporated in compute cluster 134 (e.g., as part of a storage node managed by a node manager of node managers 138).

Service frontend 116 and service frontend 128 are frontend services that interact with systems via respective job services (e.g., job service 118 of architecture 106 or job service 130 of architecture 108). In accordance with an embodiment, service frontend 116 and service frontend 128 are executed by servers or other computing devices of respective architectures 106 and 108. As shown in FIG. 1, service frontend 116 receives routed job request 154 from job router 104 and provides a job request 156 (comprising any information included in routed job request 154 and/or any information generated by service frontend 116) to job service 118, and service frontend 128 receives routed job request 164 from job router 104 and provides a job request 166 (comprising any information included in routed job request 164 and/or any information generated by service frontend 128) to job service 130.

Architectures 106 and 108 represent examples of two different job service architectures that facilitate execution of different jobs and job actions. Note that embodiments described herein are applicable to different types of job service architectures, including but not limited to, other types of architectures that include compute clusters, types of architectures that do not include compute clusters, migrating between architectures with a similar structure (e.g., but different versions of or upgraded versions of one or more components, different hosts, or different types of sub-components), and/or the like.

As stated above, architecture 106 comprises compute infrastructure 126 comprising job service 118, resource manager 120, and node 180. In accordance with an embodiment, job service 118 and resource manager 120 are configured as services of compute infrastructure 126 executing on one or more servers and/or other computing devices. In implementations, node 180 is a physical machine (e.g., a server or other computing device), a virtual machine, and/or the like. As stated elsewhere herein, compute infrastructure 126 comprises any number of nodes in addition to node 180, not shown in FIG. 1 for brevity. Furthermore, in implementations, compute infrastructure 126 comprises nodes of the same type (e.g., all physical machine nodes (also referred to as “physical nodes” or “hardware nodes” herein), all virtual machines (also referred to as “virtual nodes” herein), etc.) or different types (e.g., a mixture of physical and virtual nodes).

In accordance with an embodiment where compute infrastructure 126 comprises multiple nodes, job service 118 is implemented in a job service node (or multiple job service nodes), resource manager 126 is implemented in a resource manager node (or multiple resource manager nodes), application manager 122 is implemented in an application manager node, and containers 124 are implemented in respective containing nodes. In an alternative embodiment, job service 118 and resource manager 120 are incorporated as a single service and/or on the same server/computing device. As shown in FIG. 1, node manager 182, application manager 122, and containers 124 are implemented on a single node (node 180). In an alternative embodiment, node manager 182, application manager 122, and/or containers 124 are distributed across multiple nodes. In accordance with an embodiment, resource manager 120 and/or job service 118 are implemented on node 180.

Job service 118 is configured to submit a job to a service (also referred to as a performing a “job submission” or “submission operation” herein) and/or perform one or more job operations with respect to jobs routed to architecture 106. Examples of submission operations include, but are not limited to, submitting a job to a service (e.g., a service hosted by a container of containers 124, via resource manager 120 and application manager 122), scheduling jobs (e.g., in a queue), storing job metadata (e.g., in records 140) related to a submitted/scheduled job, and/or other operations related to submission of and/or scheduling of (e.g., new) jobs to a job service architecture. Examples of job operations include, but are not limited to, updating job metadata, listing jobs, viewing jobs, generating a report on one or more jobs executing on architecture 106, cancelling a job, pausing a job, resuming a job, yielding a job (e.g., pausing a job to free compute resources for use in executing another (e.g., higher priority) job), debugging an error with respect to a job, and/or other functions associated with respect to managing jobs executing on, executed by, and/or to be executed by a service of architecture 106. For instance, in accordance with an embodiment, job service 118 transmits a job submission 158 to resource manager 120 responsive to receiving job request 156. Job submission 158 causes (or includes instructions to cause) resource manager 120 to allocate container(s) to fulfill job request 156. In embodiments, job submission 158 comprises any information derived from (or included in) job request 156 and/or generated by job service 118.

Resource manager 120 is configured to manage node managers (e.g., node manager 182), launch application managers (e.g., application manager 122), launch (or cause launching of) applications, allocate containers (e.g., containers 124), and/or perform other operations with respect to managing resources of architecture 106. For instance, resource manager 120 receives job submission 158 from job service 118 and generates instructions 184. In embodiments, instructions 184 comprise instructions to launch application manager 122. For instance, as shown in FIG. 1, resource manager 120 transmits instructions 184 to node manager 182 to cause node manager 182 to launch application manager 122 via launch signal 186. Once application manager 122 is launched, resource manager 120 generates instructions 160. In embodiments, instructions 160 comprise instructions to allocate a container of containers 124, instructions to execute a service, instructions to perform an action of a job, instructions to obtain the status of a job, instructions to obtain data, and/or instructions to perform any other operation with respect to compute infrastructure 126, as described elsewhere herein. In an embodiment (e.g., alternative to resource manager transmitting instructions 184 to node manager), resource manager 120 transmits instructions 160 to node 180 to cause the node to launch application manager 122. In accordance with another embodiment, resource manager 120 transmits instructions 160 to application manager 122 (which is executing on a node of compute infrastructure 126) to cause application manager 122 to allocate containers 124 via container instructions 162. In accordance with another embodiment, resource manager 120 transmits instructions 160 to application manager 122 to cause application manager 122 to allocate containers 124 to perform a job of job submission 158. In accordance with an embodiment, resource manager 120 transmits instructions 160 to cause application manager 122 to allocate containers responsive to resource manager 120 receiving a request from application manager 122 (not shown in FIG. 1) for containers (also referred to as a “container request” herein).

Node manager 182 is a service implemented on node 180. In embodiments, node manager 182 is configured to manage the operation of node 180. For instance, in implementations, node manager 182 manages launching of application manager 122, memory of node 182, and other operations associated with node 180, as described elsewhere herein.

Application manager 122 is configured to receive and process job instructions associated with applications executed by and/or to be executed by containers 124. For instance, application manager 122 is configured to receive instructions 160 comprising job instructions associated with job submission 158, determine an application associated with instructions 160, and determine if the application has been launched on containers 124. If the application has not been launched, application manager 122 allocates containers 124 to execute the application and causes the application to execute on containers 124. If the application has launched on containers 124, application manager 122 transmits container instructions 162 to the allocated container(s) to perform the job.

Each container of containers 124 bundles application code together with configuration files, libraries, and dependencies. In embodiments, a container is implemented on a node (e.g., a virtual machine or a computing device) and/or another type of device for hosting applications utilized to execute jobs. For instance, as shown in FIG. 1, containers 124 are implemented on node 180. In accordance with an embodiment, a container is deployed (or deployable) across (e.g., a variety of) environments. In this manner, a container (and its application) can be tested as a unit and deployed as a container image instance. In accordance with an embodiment, a container shares an operating system with the host device executing the container.

As stated above, architecture 108 comprises a job service 130, a cluster service 132, and a compute cluster 134. In accordance with an embodiment, job service 130 and cluster service 132 are configured as services of architecture 108 executing on one or more servers and/or other computing devices. In accordance with an embodiment, compute cluster 134 comprises one or more servers and/or computing devices. For example, in accordance with an embodiment, job service 130 is implemented on a job service computing device, cluster service 132 is implemented on a cluster server, and compute cluster 134 is implemented as a set of cluster servers. In some embodiments, job service 130 and cluster service 132 are incorporated as a single service and/or on the same server/computing device.

Cluster service 132 is configured to generate, allocate, manage, and/or de-allocate compute clusters of architecture 108. For instance, cluster service 132 receives a cluster request 168 from job service 130 and allocates nodes of architecture 108 to create compute cluster 134 via allocation signal 170. In accordance with an embodiment, cluster request 168 comprises user account information, job instructions, and/or any other information suitable for creating a compute cluster on behalf of a user, a tenant, an organization, and/or the like. In some implementations, job service 130 transmits cluster request 168 in response to an initial job request from service frontend 128 and/or responsive to determining a compute cluster does not exist for the associated user account. In accordance with an embodiment, cluster service 132 transmits allocation signal 170 to a node of architecture 108 to cause the node to launch resource manager 136. In embodiments, cluster service 132 and/or resource manager 136 transmit signals to other nodes in architecture 108 to cause the nodes to be allocated to compute cluster 134. Each allocated node comprises a node manager of node managers 138. Node managers 138 are respective services implemented on the nodes to manage operations of the nodes. For instance, each node manager of node managers 138 manages launching of applications, termination of applications, memory of the node, and/or other operations associated with the respective nodes, e.g., as described elsewhere herein. Once compute cluster 134 is allocated, job service 130 is able to transmit job instructions (e.g., directly) to resource manager 136.

As a non-limiting example, cluster service 132 creates compute cluster 134 on-demand (e.g., responsive to receiving cluster request 168) by acquiring a virtual machine. For instance, suppose cluster service 132 receives cluster request 168 and determines compute cluster 134 is to be created. Cluster service 132 acquires the virtual machine from a cloud service (e.g., by transmitting a request to the cloud service for the virtual machine). Cluster service 132 causes resource manager 136 and node manager 138 to launch on the virtual machine. In another example, cluster service 132 causes multiple resource managers and/or node managers to launch on respective virtual machines of a set of virtual machines.

Job service 130 is configured to perform one or more job operations with respect to jobs routed to architecture 108. For instance, in accordance with an embodiment, job service 130 transmits a job submission 172 to resource manager 136 responsive to receiving job request 166 from service frontend 128. Job submission 172 causes (or includes instructions to cause) resource manager 136 to utilize nodes of compute cluster 134 to fulfill job request 166. In embodiments, job submission 172 comprises any information derived from (or included in) job request 166 and/or generated by job service 130.

Resource manager 136 is configured to launch (or cause launching of) applications on nodes of compute cluster 134, launch interfaces on nodes of compute cluster 134, allocate nodes of compute cluster 134 to for a job, and/or perform other operations with respect to managing resources of compute cluster 134. For instance, resource manager 136 receives job submission 172 from job service 130 and generates instructions 174. In embodiments, instructions 174 comprise instructions to launch an interface, instructions to launch an application, instructions to perform an action of a job, instructions to obtain the status of a job, instructions to obtain data, and/or instructions to perform any other operation with respect to compute cluster 134, as described elsewhere herein. For instance, in accordance with an embodiment, resource manager 136 transmits instructions 174 to a node manager of node managers 138 to cause the node manager to launch an application on the corresponding node. In accordance with another embodiment, resource manager 136 transmits instructions 174 to one or more node managers of node managers 138 to cause the nodes to be allocated to perform a job of job submission 172.

Each of node managers 138 are services implemented on respective nodes (not shown for brevity) and are configured to manage operation of the respective node. For instance, a node manager manages the launching of an interface on a node, the launching of an application on a node, termination of an interface or application on a node, scheduling of jobs to the node, routing received jobs to applications executing on the node, monitoring execution of an application on the node, reporting job status, providing responses to job submissions, memory of the node, and/or other operations associated with the node, as described elsewhere herein. In embodiments, a node manager causes its respective node to a host a cloud resource (e.g., a virtual machine, a machine learning workspace, cloud storage, and/or the like), to host a container (e.g., a container that operates in a similar manner as described with respect to containers 124), or to host an interface for an application (e.g., an application executing on the node or an application executing on another node of compute cluster 134).

Job router 104 of FIG. 1 operates in various ways to dynamically route job requests to architecture 106 or architecture 108. For instance, FIG. 2 shows a flowchart 200 of a process for dynamically routing a job request, in accordance with an example embodiment. In accordance with an embodiment, job router 104 operates in accordance with one or more steps of flowchart 200. Note not all steps of flowchart 200 need be performed in all embodiments. Further structural and operational embodiments will be apparent to persons skilled in the relevant art(s) based on the following description of FIG. 2 with respect to FIG. 1.

Flowchart 200 begins with step 202. In step 202, a job request associated with a user account is received. For example, job router 104 of FIG. 1 receives job request 150 associated with a user account of user computing device 178. In this context, job request 150 is a request to schedule a new job. In implementations, job router 104 receives job request 150 in various ways. For instance, job router 104 in accordance with an embodiment receives job request 150 in an API request. Job request 150 comprises instructions to perform/schedule a job, an indication of data to be accessed by the job, user account information, a time to complete a job by (e.g., a “deadline”), a time to start a job (e.g., a delayed start time, a deadline to start by), and/or any other information related to the job to be performed. For instance, in accordance with an embodiment, job request 150 comprises a script of code to be executed by a computing device of architecture 106 and/or 108. In accordance with an embodiment, the script is a custom script for a particular application associated with the user account. In an alternative embodiment, the script is a pre-packaged set of code (also referred to as a “task”) for performing an action. Examples of tasks include, but are not limited to, code for invoking a representational state transfer (REST) API and publishing an artifact (e.g., a collection of files or packages).

In step 204, a determination of whether or not there is a migration status for the user account is made. For example, job router 104 of FIG. 1 determines whether or not there is a migration status for the user account. Implementations of job router 104 make this determination in various ways, in embodiments. For instance, job router 104 obtains a value of a migration state of the user account (also referred to as a “MigrationState” herein) from resource provider 110. In accordance with an alternative (or additional) embodiment, job router maintains a mapping of migration statuses to account IDs (e.g., in a data store, such as data store 144). In a further alternative embodiment, resource provider system 110 updates the mapping in response to changes in a user account's migration status. If there is a migration status, flowchart 200 continues to step 206. Otherwise, flowchart 200 continues to step 220.

In step 206, a determination of whether or not the migration status is enabled is made. For example, job router 104 of FIG. 1 determines whether or not the migration status of the user account is enabled based on configuration data 152. Example values of a migration state are shown in Table 1 below:

TABLE 1

| Migration | Active | Active Job | Job API | List API | Job Record |
|---|---|---|---|---|---|
| State Value | Architecture | Service | Service | Service | Syncing |
| N/A | Arch. 106 | JS 118 | SF 116, JS 118 | SF 116 | Disabled |
| Preparing | Arch. 106 | JS 118 | SF 116, JS 118 | SF 116 | Enabled |
| Enabled | Arch. 108 | JS 130 | SF 128, JS 130/ | JDCS | Enabled |
| | | | SF 116, JS 118 | | |
| Disabled | Arch. 106 | JS 118 | SF 128, JS 130/ | JDCS | Enabled |
| | | | SF 116, JS 118 | | |

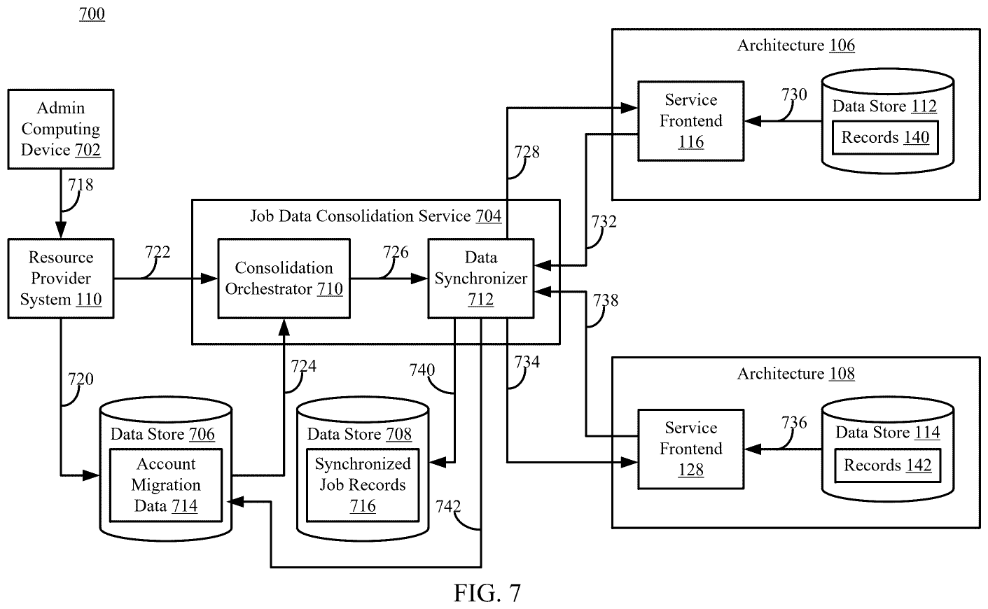

As shown in Table 1, a value of the migration state for a user account, in embodiments, can be “non-existing” (or “N/A” as shown in Table 1), indicating the user account is not being migrated from one architecture to another, be in a “preparing” state that indicates the account is being prepared for migration, be in an “enabled” state that indicates migration is enabled for the account, or be in a “disabled” state indicating that migration has begun but is disabled (or paused). If the migration state does not exist, the user account is utilizing a single architecture (e.g., a legacy or original architecture), such as architecture 106. In this context, job service 118 is the active job service (i.e., the job service that is performing and/or scheduling jobs for the user account), service frontend 116 is the active job API service (e.g., the service that job router 104 is interacting with to schedule jobs or otherwise fulfill job requests), service frontend 116 is the active list API service (e.g., the service utilized to fulfill job report requests), and record syncing between architectures 106 and 108 is disabled. In the “preparing” state (also referred to as the “pending” state), migration is enabled for the user account; however, architecture 106 is still the active architecture as architecture 108 is not prepared for use yet. In this context, the active job service, the job API service, the active list API service are the same as if the migration state did not exist and record syncing is disabled. In the “enabled” state, migration is enabled and active for the user account. In this context, architecture 108 is the active architecture (e.g., the architecture to which new job requests are scheduled), job service 130 is the active job service, both service frontends 116 and 128 are active job API services (e.g., service frontend 116 is still utilized for fulfilling requests related to jobs already scheduled to job service 118), a job data consolidation service is utilized for fulfilling job report and listing requests (as described further with respect to FIGS. 7-12), and job record syncing is enabled. In the “disabled” state, a migration status exists but is disabled (e.g., paused, reversed, or otherwise halted). In this context, the active architecture is architecture 106, job service 118 is the active job service, both service frontends 116 and 128 are active (e.g., if existing jobs are still executing on architecture 108, otherwise service frontend 116 is active and service frontend 128 is inactive), the job data consolidation service is the active list API service, and job record syncing is enabled. While Table 1 shows a job data consolidation service being used for fulfilling job reports, some embodiments route job report requests to the architecture managing the corresponding job.

In accordance with an embodiment, resource provider system 110 maintains a mapping of user accounts to migration states. For instance, Table 2 shows an example table of migration state data for N user accounts:

TABLE 2

| | Migration | Source | Target |
|---|---|---|---|
| Account ID | State | Architecture | Architecture |
| Account 1 | Enabled | Arch. 106 | Arch. 108 |
| Account 2 | N/A | Arch. 106 | None |
| Account 3 | Disabled | Arch. 106 | Arch. 108 |
| • • • | • • • | • • • | • • • |
| Account N | Preparing | Arch. 106 | Arch. 108 |

As shown in Table 2, the migration state for an “Account 1” is enabled and the user account is being migrated from architecture 106 to architecture 108. In this context, architecture 106 is referred to as a “source architecture” (i.e., the job service architecture in which the account previously used) and architecture 108 is referred to as a “target architecture (i.e., the job service architecture in which the account is being migrated to). As also shown in Table 2, there is no migration state for an “Account 2”. In this context, the job records and job performance operations of Account 2 are remaining in architecture 106 and not being migrated to architecture 108, as such there is no target architecture for Account 2's (non-existent) migration. As further shown in Table 2, an “Account 3” is in a disabled migration state and an “Account N” is in a preparing migration state, each with architecture 106 as a source architecture and architecture 108 as a target architecture.

In an embodiment, and as shown in FIG. 1, job router receives configuration data 152 from resource provider system 110. In this context, configuration data 152 comprises the value of the migration status. If the migration status is enabled, flowchart 200 continues to step 208. If the migration status is not enabled (e.g., the migration status is disabled or pending), flowchart 200 continues to step 214.

In step 208, the job request is routed to a second job service architecture. For example, job router 104 of FIG. 1 routes a routed job request 164 to service frontend 128 of architecture 108. Implementations of job router 104 route job requests to architecture 108 in various ways. For instance, job router 104 in an embodiment transmits routed job request 164 in a routed API request to service frontend 128. As described herein, routed job request 164 comprises some or all of the information included in job request 150. In some embodiments, routed job request 164 also includes information related to the account configuration of the user account (e.g., data included in configuration data 152).

In step 210, a determination of whether or not the job request was accepted by the second job service architecture is made. For example, subsequent to transmitting routed job request 164, job router 104 of FIG. 1 receives a response (not shown in FIG. 1 for brevity) from frontend 128. In embodiments, the response includes an indication that architecture 108 (or a component thereof, e.g., job service 130) accepted routed job request 164 (e.g., a verification indication, a confirmation indication, a confirmation message, and/or the like) or an indication that architecture 108 (or a component thereof) did not accept routed job request 164 (e.g., an error message, an error code, a rejection message, and/or the like). In accordance with an embodiment, a indicating the job request was not accepted includes a reason for why the job was not accepted (e.g., data addressed by the job request is not included in or otherwise available to architecture 108, architecture 108 does not include the resources for performing the job, a job queue of architecture 108 is full, and/or another reason a job would not be accepted by a job service, as described elsewhere herein). If architecture 108 accepted routed job request 164, architecture 108 schedules the job and flowchart 200 ends with step 222. Otherwise, flowchart 200 continues to step 212.

In step 212, an error message is returned to the requesting application. For example, job router 104 of FIG. 1 transmits an error message (not shown in FIG. 1) to user computing device 178 (e.g., via gateway 102). In some examples, job router 104 provides an error message to resource provider system 110 (e.g., in addition to and/or in lieu of providing an error message to user computing device 178) indicating scheduling the job request was unsuccessful. In embodiments, the error message comprises a job ID of the job request, an account ID of the user account, an error code provided by architecture 108, an error message received from architecture 108, a timestamp of when the attempt to schedule the job was made, a timestamp of when the job request was received, and/or any other information associated with the attempt to schedule the job.

In implementations, resource provider system 110 utilizes information indicative that a job failed to be scheduled to an architecture (e.g., the first failure to schedule, after a number of attempts to schedule the job fail, after attempts to schedule the job to either architecture fail, and/or the like) to identify an error in the operation of architecture 106 and/or 108. In some embodiments, resource provider system 110 performs a corrective action responsive to the information provided by job router 104. Examples of corrective actions include, but are not limited to, disabling a migration state of the user account, debugging software of architecture 106 and/or architecture 108 (or software of component(s) thereof), deploying a software update to architecture 106 and/or architecture 108 (or to component(s) thereof), allocating additional resources (e.g., containers for architecture 106, nodes for architecture 108, and/or the like) to architecture 106 and/108, identifying errors in account configuration data for the user account, resolving errors in account configuration data for the user account, and/or performing another action in an attempt to correct an error in the operation of architecture 106 and/or architecture 108. For instance, as a non-limiting example, suppose job router 104 provides an indication to resource provider system 110 that scheduling routed job request 164 to architecture 108 failed. In this example, resource provider system 110 changes the value of the migration state for the user account from “enabled” to “disabled” and attempts to identify and/or resolve errors in architecture 108. In the meantime, the user account is able to utilize architecture 106 to schedule jobs to be performed.

In step 214, the job request is routed to a first job service architecture. For example, job router 104 of FIG. 1 transmits routed job request 154 to service frontend 116 of architecture 106. Implementations of job router 104 route job requests to architecture 106 in various ways. For instance, job router 104 in accordance with an embodiment transmits routed job request 154 as a routed API request to service frontend 116. As described herein, routed job request 154 comprises some or all of the information included in job request 150. In some embodiments, routed job request 154 also includes information related to the account configuration of the user account (e.g., data included in configuration data 152).

In step 216, a determination of whether or not the job request was accepted by the first job service architecture is made. For example, subsequent to transmitting routed job request 154, job router 104 receives a response (not shown in FIG. 1 for brevity) from frontend 116. In embodiments, the response includes an indication that architecture 106 (or a component thereof, e.g., job service 118) accepted routed job request 154 or an indication that architecture 106 did not accept routed job request 154. In accordance with an embodiment, a version of the response indicating the job request was not accepted includes a reason for why the job was not accepted. If architecture 106 accepted routed job request 154, architecture 106 schedules the job and flowchart 200 ends with step 222. Otherwise, flowchart 200 continues to step 218.

In step 218, an error message is returned to the requesting application. For example, job router 104 of FIG. 1 transmits an error message (not shown in FIG. 1) in a similar manner as described with respect to step 212. In a similar manner as described with respect to step 212, the error message comprises a job ID of the job request, an account ID of the user account, an error code provided by architecture 106 and/or 108, an error message received from architecture 106 and/or 108, a timestamp of when the attempt to schedule the job was made, a timestamp of when the job request was received, and/or any other information associated with the attempts to schedule the job.

In step 220, the job request is routed to a first job service architecture. For example, job router 104 of FIG. 1 transmits routed job request 154 to service frontend 116 to cause architecture 106 (or a component thereof, e.g., job service 118) to schedule the job. In this context, job router transmits routed job request 154 in a similar manner as described with respect to steps 214-218.

In step 222, a mapping of a job ID of the job request to the routed job service architecture is stored in a cache. For example, job router 104 of FIG. 1 updates job metadata cache 146 with job routing data 176. By maintaining a distributed cache (e.g., job metadata cache 146) of mappings between job IDs of job requests and routed job service architectures, embodiments of system 100 improve routing of existing jobs and scheduling of new jobs in reference to a user account undergoing migration. For instance, if a received job request refers to an ongoing job, job router 104 is able to access job metadata cache 146 and route the received job request to the architecture performing the existing job. In this context, requests related to viewing, cancelling, pausing, resuming, debugging, and performing other operations with respect to existing jobs are able to be fulfilled during account migration without requiring the user to directly refer to the appropriate architecture, irrespective of the migration state of the user account.

Thus, an example process for dynamically routing job requests for new jobs has been described with respect to flowchart 200 of FIG. 2. By dynamically routing jobs in this manner, embodiments of job router 104 enable migration with little to no impact on a user account's front end service (e.g., the user interface of user computing device 178). For instance, a user account is able to submit new job requests regardless of the migration state of the user account, as job router 104 routes the new job request to the “active” job service for the user account,

In implementations, a user submits job requests related to existing jobs (e.g., job listings requests, requests to cancel jobs, requests to pause jobs, requests to debug a job, requests to get job information, and/or the like). To better understand the operation of job router 104 routing job requests related to existing jobs to architectures 106 and 108, FIG. 1 is described in reference to FIG. 3A. FIG. 3A shows a sequence diagram 300 that illustrates a process by which a job request for an existing job is dynamically routed to a job service architecture within system 100 of FIG. 1. As shown in sequence diagram 300, gateway 102 receives user input 302. In an embodiment, user input 302 is a further example of user input 148 of FIG. 1. In embodiments, user input 302 specifies an operation to be performed with respect to an existing job (e.g., cancel the job, list jobs for an account, pause the job, provide a status for the job, and/or the like). In accordance with an embodiment, user input 302 includes a job ID that uniquely identifies the job, a user account ID that uniquely identifies the user account, an authentication token that attests the authenticity of user input 302, credentials for verifying authenticity of user input 302, and/or any other information associated with the user account and/or the job being requested. In accordance with an embodiment, computing device 178 generates user input 302 responsive to user interaction with a user interface of computing device 178.

While examples are described with respect to user input 302, in other embodiments, gateway 102 receives input from an application or computing device based on an automatic or semi-automatic function of the application or computing device. For instance, in an embodiment, an application is configured to routinely request the status of a job or jobs for a user account. In another embodiment, an application is configured to submit a job request for an existing job in response to a triggering event. In other embodiments, applications or devices are configured to provide input (e.g., other than user input 302, in lieu of user input 302, or responsive to user input 302) to gateway 102 (e.g., on behalf of a user account).

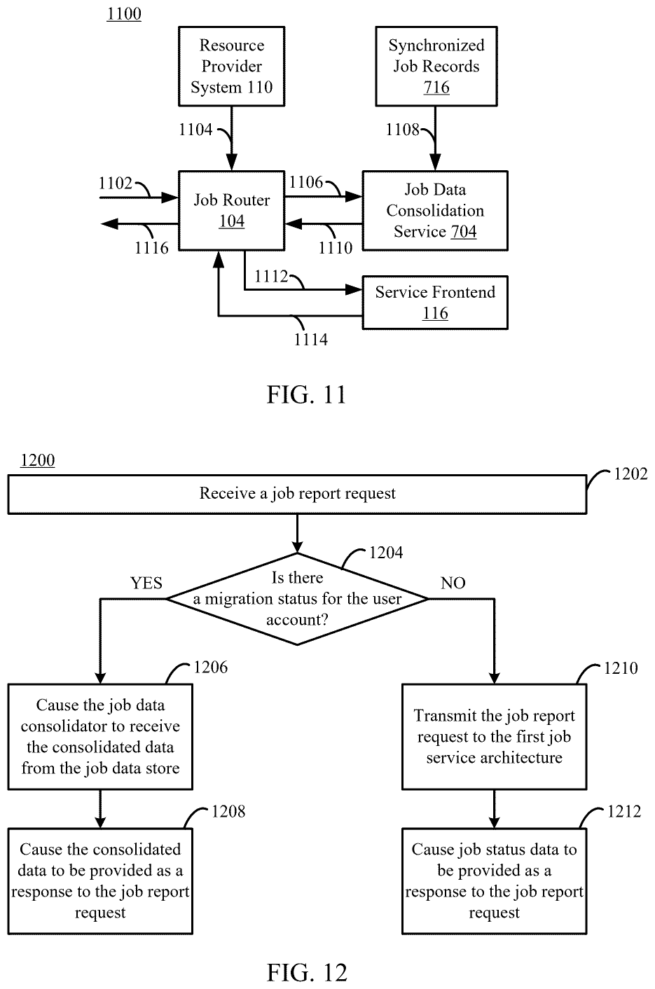

As shown in FIG. 3A, gateway 102, responsive to receiving user input 302, generates an application programming interface (API) request 304. API request 304 is a further example of job request 150, as described with respect to FIG. 1. API request 304 specifies any information included in or derived from user input 302, in embodiments. In accordance with an embodiment, API request 304 is a job request; however, embodiments described herein are not so limited. For instance, as further described with respect to FIGS. 11 and 12, API request 304 is a job report request.

Responsive to receiving API request 304, job router 104 determines where to route API request 304. For instance, as shown in sequence diagram 300 of FIG. 3A, job router 104 transmits a configuration request 306 to resource provider 110 to obtain configuration data for the user account associated with API request 304. In accordance with an embodiment, configuration request 306 comprises an account ID of the user account (and, optionally, a credential or token authenticating/attesting-authenticity-of the user account).

Resource provider system 110 receives the configuration request 306 and determines the state of the user account. In implementations, the value of the migration state of the user account indicates the active architecture for the user account, the active job service of the user account, an active job API service for the account, an active list API service for the account, whether or not job records are syncing between architectures for the account, and/or any other information associated with whether or not the account is migrated or not, as described herein, provider system 110. In embodiments, resource provider 110 determines the value of (and/or the existence of) the migration state of the user account and provides it as a configuration response 208. In embodiments, configuration response 308 comprises configuration data (e.g., configuration data 152 of FIG. 1). For instance, configuration response 308 in an example specifies the migration state of the user account. In some embodiments, configuration response 308 comprises information associated with the specified state. For instance, if the state is enabled, configuration response 308 in accordance with an embodiment specifies architecture 108 as the active architecture, job service 130 as the active job service, frontends 116 and 118 as active job API services, a job data consolidation service as the active job report service, and/or that job record syncing is enabled.

Job router 104 receives configuration response 308 and performs an analysis step 310. In analysis step 310, job router 104 analyzes configuration response 308 and determines if there is a migration status for the user account and, if so, whether or not the migration state is enabled. The sequence shown in sequence diagram 300 continues depending on whether or not the migration state, also referred to as “MigrationState”, exists and its value.

For instance, if job router 104 determines there is no MigrationState for the user account, job router 104 transmits a routed API request 312 to frontend 116. Routed API request 312 is a further example of routed job request 154, as described with respect to FIG. 1. Routed API request 312 is a routed version of API request 304 and, in implementations, comprises any (e.g., some or all) information included in API request 304. Frontend 116 receives routed API request 312 and causes job service 118 to perform a job operation with respect to the job based on routed API request 312. If the job operation is successfully performed, frontend 116 transmits a response 314 to job router 104 indicating the operation was performed. In this context, and as shown in FIG. 3, job router 104 provides a response 316 to gateway 102 (which, in some embodiments, provides a further response to user computing device 178) indicating the operation was successfully performed. In some embodiments, job service 118 fails to perform the job operation, in this context, responses 314 and/or 316 indicate the job operation was unsuccess. Depending on the implementation, job router 104 and/or frontend 116 attempt to reschedule the job and/or gateway 102 provides an indication to user computing device 178 that the job was unsuccessfully scheduled.

If job router 104 determines there is a MigrationState for the user account and it is enabled, job router 104 transmits a routed API request 320 to frontend 128. Routed API request 320 is a further example of routed job request 164, as described with respect to FIG. 1. Routed API request 320 is a routed version of API request 304 and, in implementations, comprises any (e.g., some or all) information included in API request 304. Frontend 128 receives routed API request 320 and causes job service 130 to execute a job operation based on routed API request 320. In embodiments, and as shown in FIG. 3, frontend 128 provides a response 322 to job router 104 indicating whether or not executing the job operation associated with routed API request 320 was successful. If response 322 indicates routed API request 320 was successful (e.g., the job was found in architecture 108), job router 104 transmits a response 324 to gateway 102 indicating API request 304 is fulfilled. In some embodiments, gateway 102 provides a response (not shown in FIG. 2) to computing device 178 indicating the job request indicated in user input 202 is scheduled.

If response 322 indicates routed API request 320 was unsuccessful, job router 104 transmits a routed API request 326 to frontend 116. For instance, if the job related to routed API request 320 (i.e., the job indicated in API request 304) is not found in architecture 108, job router 104 transmits routed API request 326 to frontend 116. Routed API request 326 is a further example of routed job request 154, as described with respect to FIG. 1. Routed API request 326 is a routed version of API request 304 and, in implementations, comprises any (e.g., some or all) information included in API request 304. Frontend 116 receives routed API request 326 and causes job service 118 to execute a job operation based on routed API request 326. In embodiments, and as shown in FIG. 3A, frontend 116 provides a response 328 to job router 104 indicating whether or not executing the job operation associated with routed API request 326 was successful. If response 328 indicates routed API request 326 was successful, job router 104 transmits a response 330 to gateway 102 indicating API request 304 is fulfilled. In some embodiments, gateway 102 provides a response (not shown in FIG. 3A) to computing device 178 indicating the job request indicated in user input 302 is fulfilled (and, optionally, including a result of the job operation). If response 328 indicates routed API request 326 was unsuccessful, depending on the implementation, job router 104 attempts to re-route the job request (e.g., either to frontend 116 or 128) (e.g., a predetermined number of times) or transmits response 330 to gateway 102 indicating API request 204 is unsuccessful. In some embodiments in this context, gateway 102 indicates to computing device 178 that executing the job operation request indicated in user input 202 was unsuccessful.

If job router 104 determines there is a MigrationState for the user account and it is disabled, job router 104 transmits a routed API request 334 to frontend 116. Routed API request 334 is a further example of routed job request 154, as described with respect to FIG. 1. Routed API request 334 is a routed version of API request 304 and, in implementations, comprises any (e.g., some or all) information included in API request 304. Frontend 116 receives routed API request 334 and causes job service 118 to execute a job operation based on routed API request 334. In embodiments, and as shown in FIG. 3A, frontend 116 provides a response 336 to job router 104 indicating whether or not executing the job operation associated with routed API request 334 was successful. If response 334 indicates routed API request 334 was successful, job router 104 transmits a response 338 to gateway 102 indicating API request 304 is fulfilled. In some embodiments, gateway 102 provides a response (not shown in FIG. 3A) to computing device 178 indicating the job operation request indicated in user input 302 is routed for execution, is executing or was executed.

If response 336 indicates routed API request 334 was unsuccessful and architecture 108 is in an unusable state, job router 104, depending on the implementation, either attempts to reroute routed API request 334 to frontend 116 or provides response 338 to gateway 102 indicating fulfilling API request 304 was unsuccessful. In some embodiments, gateway 102 provides a response (not shown in FIG. 2) to computing device 178 indicating that executing the job operation with respect to the existing job indicated in user input 302 was unsuccessful.

If response 336 indicates routed API request 334 was unsuccessful and architecture 108 is in a usable state (e.g., only a portion of architecture 108 is being maintained, architecture 108 is not actively performing jobs but a queue for jobs to be performed is enabled, architecture 108 is operating at a reduced capacity, and/or the like), job router 104 transmits a routed API request 340 to frontend 128. Routed API request 340 is a further example of routed job request 164, as described with respect to FIG. 1. Routed API request 340 is a routed version of API request 304 and, in implementations, comprises any (e.g., some or all) information included in API request 304. Frontend 128 receives routed API request 340 and causes job service 130 to execute a job operation based on routed API request 340. In embodiments, and as shown in FIG. 3A, frontend 128 provides a response 342 to job router 104 indicating whether or not executing the job operation associated with routed API request 340 was successful. If response 342 indicates routed API request 340 was successful, job router 104 transmits a response 344 to gateway 102 indicating API request 304 is fulfilled. In some embodiments, gateway 102 provides a response (not shown in FIG. 3A) to computing device 178 indicating the job request indicated in user input 302 is executed (or is to be executed or is executing). If response 342 indicates routed API request 340 was unsuccessful, depending on the implementation, job router 104 attempts to re-route the job operation (e.g., either to frontend 116 or 128) (e.g., a predetermined number of times) or transmits response 344 to gateway 102 indicating API request 304 is unsuccessful. In some embodiments in this context, gateway 102 indicates to computing device 178 that executing the job operation indicated in user input 302 was unsuccessful.

By dynamically routing job requests based on a migration state of a user account, embodiments of job router 104 enable a user to continue submitting jobs to be performed by a job service architecture irrespective of whether or not a resource provider is in the process of migrating the corresponding user account from one architect to another. Furthermore, in some embodiments, the user is not required to alter the format of the user input (or the information included therein) based on the current migration state. Instead, job router 104 routes and processes requests in a manner that is suitable for the receiving frontend. In this manner, the user experience (e.g., user interface and associated display) are improved as the user is not required to learn a new interface or modify their input to perform jobs. Furthermore, computing devices (and applications executing thereon) acting on behalf of a user are not required to change format or information included in requests submitted to gateway 102.

Thus, example sequences of routing a job operation with respect to an existing job have been described in reference to sequence diagram 300 of FIG. 3A. As described with respect to sequence diagram 300, job router 104 determines where to route a job request (e.g., API request 304) in various ways. In some embodiments, job router 104 utilizes job metadata cache 146 to determine where to route API request 304. To better understand the operation of job router 104 (and other components of system 100), FIG. 1 and FIG. 3A are further described with respect to FIG. 3B. FIG. 3B shows a sequence diagram 350 that illustrates a process by which a job operation request is dynamically routed to a job service architecture within the example system of FIG. 1. As shown in sequence diagram 350, gateway 102 receives user input 302 and transmits API request 304 to job router 104, as described with respect to sequence diagram 300 of FIG. 3A. As described with respect to sequence diagram 300, job router 104 determines which architecture to route API request 304 to. In an example embodiment, and as shown in sequence diagram 350, job router 104 searches job metadata cache 146 via cache search operation 352 (“search 352” herein). In accordance with an embodiment, job router 104 performs search 352 by utilizing a job ID of the existing job indicated in API request 304 as an index.

If search 352 results in finding a match, job router 104 receives response 354 indicating which architecture the existing job is executing in, managed by, and/or scheduled to. In this context, job router 104 routes API request 304 to the appropriate architecture. For instance, as shown in FIG. 3B, if the job is mapped to architecture 106, job router 104 transmits a routed API request 356 to service frontend 116. If the job is mapped to architecture 108, job router 104 transmits a routed API request 358 to service frontend 128. In embodiments routed API request 356 and/or routed API request 358 comprise information/data/indications/instructions included in API request 304. In some embodiments, if routed API request 356 fails, job router 104 reroutes the API request to service frontend 128 and if API request 358 fails, job router 104 reroutes the API request to service frontend 116. In accordance with an embodiment, if routed API request 356 and/or 358 is successful, job router 104 receives a response indicating the job operation was successfully queued/accepted/executed/etc. In accordance with an embodiment, job router transmits a response to gateway 102 indicating the job operation was successful. If the job operation was unsuccessful (and, optionally, unsuccessfully rerouted), job router 104 transmits an error message to router 102 and/or user computing device 178.

By searching job metadata cache 146 for existing jobs, job router 104 is able to route a job operation without having to determine a migration status of the account. In this context, network traffic to resource provider system 110 is reduced and compute resources expended by resource provider system 110 are reduced. Furthermore, by maintaining job metadata in job metadata cache 146, network traffic to route requests to architecture 106 and architecture 108 is reduced as both architectures do not need to be checked in order to route a job operation request for an existing job. In an alternative embodiment, job router 104 still obtains a migration status of the user account. For instance, if the job metadata cache indicates the job is routed to architecture 108, job router 104 receives configuration data from resource provider 110 to determine if architecture 108 is active (e.g., the migration state of the user account is enabled). If so, job router 104 transmits routed API request 358. If not, depending on the implementation, job router 104 attempts to transmit routed API request 358 (e.g., if migration status is disabled but architecture 108 is in a usable state), returns an error (not shown in FIG. 3B) to gateway 102 (and computing device 178) indicating the job operation could not be executed (e.g., if migration status is disabled and architecture 108 is not in a usable state), or attempts to fulfill API request 304 without transmitting a request to architecture 108 (e.g., fulfilling a job listing request utilizing a job consolidation service, e.g., as described further with respect to FIGS. 11 and 12).

If search 352 fails to result in a match (e.g., there is no job metadata for the job indicated in API request 304 in job metadata cache 146), job router 104 transmits configuration request 306, receives configuration response 308, and performs analyzation step 310 in a similar manner as described with respect to sequence diagram 300 of FIG. 3A. Furthermore, sequence of operations occurs in a similar manner as described with respect to the remainder of sequence diagram 300. If a job operation is successfully routed to an architecture (e.g., as indicated by response 314, response 322, response 328, response 336, and/or response 342), job router 104 updates job metadata cache 146 via cache update step 360 to include a mapping of the job ID of the job indicated in API request 304 and the architecture to which the job operation was successfully routed to. In this context, job router 104 resolves missing information in job metadata cache 146 such that subsequent operations with respect to the job submitted to job router 104 (e.g., via gateway 102) are able to utilize the mapping in job metadata cache 146 to determine where to route the operation request to. In this manner, further compute resource expenditure and time are reduced by maintaining job metadata cache 146. Furthermore, job router 104 performs the sequence shown in sequence diagram 350 to automatically refresh/complete job metadata cache 146. As shown in FIG. 3B, job router 104 provides a response 362 indicating the job operation was successfully routed to a job service architecture.

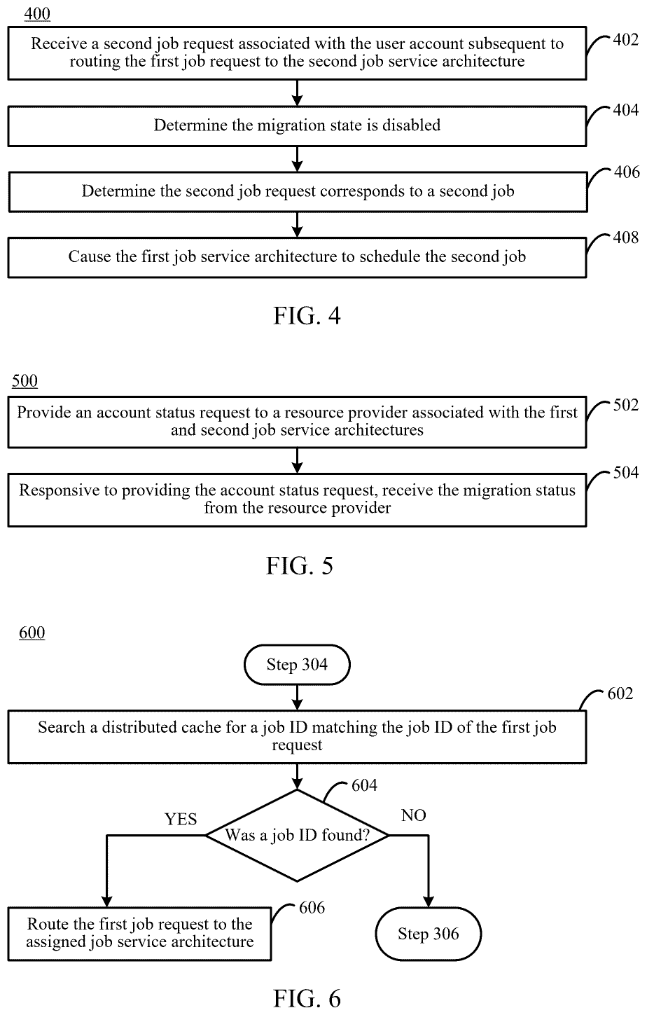

As described herein, job router 104 is able to dynamically route job requests to different job service architectures associated with a user account. For instance, if a user account is being migrated from architecture 106 to architecture 108, job router 104 (in an implementation) routes new jobs to architecture 108. However, a developer or provider of architecture 108 may disable or otherwise prevent new jobs from being routed to architecture 108 (e.g., for maintenance, for upgrading software, for rolling back a feature, for deploying new features, for testing, responsive to a reported issue, responsive to functional impact (e.g., that satisfies an impact criterion), responsive to performance impact (e.g., that satisfies a performance criterion), and/or the like). In this context, job router 104 in accordance with an embodiment determines to route a new job to architecture 106 instead of waiting for architecture 108 to become available again. Job router 104 operates in various ways to dynamically route jobs to another (e.g., older or previously used) job service architecture (e.g., instead of the (e.g., newer or upgraded) job service architecture). For instance, FIG. 4 shows a flowchart 400 of a process for routing a job request subsequent to a disabling of a migration state, in accordance with another example embodiment. In accordance with an embodiment, job router 104 operates in accordance with one or more steps of flowchart 400. Note not all steps of flowchart 400 need be performed in all embodiments. In some embodiments, flowchart 400 is performed subsequent to a job request being routed to a second job service architecture (e.g., as described with respect to step 208 or step 218 of flowchart 200 of FIG. 2). Further structural and operational embodiments will be apparent to persons skilled in the relevant art(s) based on the following description of FIG. 4 with respect to FIG. 1.

Flowchart 400 begins with step 402. In step 402, a second job request associated with the user account is received subsequent to routing the first job request the second job service architecture. For example, suppose job router 104 of FIG. 1 receives a second job request (not shown in FIG. 1 for brevity) subsequent to having routed job request 150 to service frontend 128 as routed job request 164 (e.g., and service frontend 128 successfully causing job service 130 to schedule the job associated with job request 150).

In step 404, the migration state is determined to be disabled. For example, suppose job router 104 of FIG. 1 receives updated account configuration data for the user account from resource provider system 110 (e.g., in a similar manner as configuration response 308 is received in FIG. 3A). In this context, further suppose the migration state of the user account is now disabled. For instance, resource provider system 110 updated the migration state to disabled to troubleshoot, debug, rollback, deploy software to, or otherwise modify architecture 108, as described elsewhere herein.

In step 406, the second job request is determined to correspond to a second job. For example, job router 104 of FIG. 1 determines the second job request corresponds to a second job that is different than the job that job request 150 corresponded to. In accordance with an embodiment, job router 104 determines the job corresponds to a different job based on the job ID of the second job request (e.g., by comparing the job ID with the job ID of the first job). In accordance with an embodiment, job router 104 determines the job corresponds to a new job by accessing job metadata cache 146 and failing to find a matching job ID, e.g., as further described with respect to FIG. 6.

In step 408, the first job service architecture is caused to schedule the second job. For example, job router 104 of FIG. 1 transmits a routed job request to service frontend 116, in a similar manner as described with respect to step 214 of flowchart 200 of FIG. 2. In this context, the second job is scheduled by job service 118 and job router 104 updates job metadata cache 146 with a mapping of the second job to architecture 106.

Thus, several example scenarios of routing job requests for a user account have been described with respect to FIGS. 1-4. By dynamically routing jobs dependent on a migration state of a user account, embodiments of job router 104 enable user account migration with little to no impact on the user account's front-end service. For instance, the user interface of user computing device 178 in a non-limiting example displays the same interface regardless of whether architecture 106 or architecture 108 is utilized. Furthermore, job router 104 supports interaction with/utilization of multiple types of user interfaces of user computing device 178 including, but not limited to, web browser based interfaces, tools in an integrated development environment, pipeline interfaces, API interfaces, command line tools, etc. User and/or application interaction with these types of interfaces is uninterrupted by migration of the user account through the use of job router 104. In another example, the user account is able to migrate from architecture 106 to architecture 108 (or vice versa) without requiring user input. This allows resource provider system 110 to migrate user accounts at a pace suitable for the resource provider. For instance, a resource provider is able to migrate (e.g., all) user accounts from a legacy job service architecture (e.g., architecture 106, in an embodiment) and, once all accounts have been migrated, deprecate the legacy architecture. This reduces maintenance cost and resource consumption for the resource provider without having to wait on interaction by or steps performed by the user account. Furthermore, the migration state of a user account can be toggled between “disabled” and “enabled” during the course of migration. This functionality allows a resource provider to selectively disable an architecture for maintenance, troubleshooting, rolling back updates, deploying updates, and/or the like, without impacting the user experience for the user account.

As described herein, job router 104 is configured to determine a migration status of a user account. In some embodiments, the migration status of a user account is maintained by a resource provider system (e.g., resource provider system 110). In this context, job router 104 operates in various ways to determine the migration status maintained by resource provider system 110. For example, FIG. 5 shows a flowchart 500 of a process for determining a migration status of a user account, in accordance with an example embodiment. In accordance with an embodiment, job router 104 operates in accordance with one or more steps of flowchart 500. Note not all steps of flowchart 500 need be performed in all embodiments. In accordance with an embodiment, flowchart 500 is a sub-step of step 204 of flowchart 200 of FIG. 2 or step 404 of flowchart 400 of FIG. 4. Further structural and operational embodiments will be apparent to persons skilled in the relevant art(s) based on the following description of FIG. 5 with respect to FIG. 1.

Flowchart 500 begins with step 502. In step 502, an account status request is provided to a resource provider associated with the first and second job service architectures. For example, job router 104 of FIG. 1 provides an account status request to resource provider system 110. The account status request includes an identifier of the user account and causes resource provider system 110 to locate and provide configuration data and/or other information associated with the status of the user account. In accordance with an embodiment, and as described with respect to FIG. 3A, the account status request is also referred to as a “configuration request.”

In step 504, responsive to providing the account status request, the migration status is received from the resource provider. For example, job router 104 of FIG. 1, responsive to providing the account status request to resource provider system 110, job router 104 receives a migration status from resource provider system 110. For instance, as shown in FIG. 1, the migration status is included in configuration data 152. As described with respect to FIG. 3A, the migration status is included in configuration response 308.

In some embodiments, a job request relates to an existing job. In this context, job router 104 routes the job request to the job service architecture assigned the existing job. Job router 104 operates in various ways to determine whether or not a job request relates to an existing job and dynamically route the job request based on the determination, in embodiments. For example, FIG. 6 shows a flowchart 600 of a process for determining to dynamically route a job request, in accordance with an example embodiment. In accordance with an embodiment, job router 104 operates in accordance with one or more steps of flowchart 600. Note not all steps of flowchart 600 need be performed in all embodiments. Further structural and operational embodiments will be apparent to persons skilled in the relevant art(s) based on the following description of FIG. 6 with respect to FIG. 1.

As shown in FIG. 6, flowchart 600 begins with step 204, as described with respect to flowchart 200 of FIG. 2. Flowchart 600 continues to step 602. In step 602, a distributed cache is searched for a job ID matching the job ID of the first job request. For example, job router 104 searches job metadata cache 146 for a job ID matching the job ID of job request 150. In accordance with an embodiment, job router 104 utilizes the job ID included in job request 150 as an index against job metadata cache 146.

In step 604, a determination of whether or not the job ID was found in the distributed cache is made. For example, job router 104 of FIG. 1 determines whether or not the job ID was found in job metadata cache 146. For instance, job router 104 in an example fails to find the job ID in job metadata cache 146. In this context, flowchart 600 continues to step 206 of flowchart 200, as described with respect to FIG. 2. Alternatively, job router 104 locates a matching job ID in job metadata cache 146. In this context, job router 104 obtains cached information stored in job metadata cache 146 for the matched job ID and flowchart 600 continues to step 606.

In step 606, the first job request is routed to the assigned job service architecture. For example, job router 104 receives cached information from job metadata cache 146. In embodiments, cached information comprises the job ID, an architecture ID or job service ID that indicates the architecture and/or job service the job is routed to, and/or any other information associated with the scheduled job. In this context, job router 104 routes job request 150 to the job service architecture that was assigned the job (e.g., as routed job 154 if architecture 106 was assigned or as routed job 164 if architecture 108 was assigned).

### III. Example Embodiments for Consolidating Job Data

In embodiments, users, user accounts, applications, nodes executing jobs, containers executing jobs, and/or the like access data related to executing or executed jobs. For instance, a user in an implementation interfaces with user computing device 178 of FIG. 1 to issue a job list request to a job service. Examples of job list requests (also referred to as job report requests) are utilized for listing jobs, listing pipelines, and/or performing other query operations such as filtering, topping, skipping, counting, etc. (e.g., with or without pagination support). To support these operations, some embodiments described herein implement job data consolidation, where job records between the source architecture for a user account (e.g., architecture 106) and the target architecture for the user account (e.g., architecture 108) are synchronized. In some implementations, job records are duplicated across architectures.

Alternatively, a separate service is utilized to consolidate data between the architectures. In this context, a “job data consolidation service” consolidates job records between architectures 106 and 108. Systems including a job data consolidation service are configured in various ways, in embodiments. For example, FIG. 7 shows a block diagram of a system 700 for preparing a user account for migration and consolidating job data, in accordance with another example embodiment. As shown in FIG. 7, system 700 comprises architecture 106 (comprising at least data store 112 (storing records 140) and service frontend 116, as well as other components not shown in FIG. 7 for brevity), architecture 108 (comprising at least data store 114 (storing records 142) and service frontend 128, as well as other components not shown in FIG. 7 for brevity), and resource provider system 110, as described with respect to FIG. 1, as well as an admin computing device 702, a job data consolidation service 704, a data store 706, and a data store 708.

Data stores 706 and 708 are configured to store data utilized by and/or generated by resource provider system 110, job data consolidation service 704, and/or other components (or subcomponents) of system 700. For instance, as shown in FIG. 1, data store 706 stores account migration data 714 and data store 708 stores synchronized job records 716. In accordance with an embodiment, account migration data 714 comprises a mapping between user account IDs and migration statuses (e.g., as described with respect to Table 2 in reference to FIG. 2). In accordance with an embodiment, synchronized job records 716 comprises data and/or metadata of records of jobs performed by, scheduled to, and/or executing on architectures 106 and/or 108. While data stores 706 and 708 are shown as separate data stores in FIG. 7, in an alternative embodiment, data store 706 and data store 708 are incorporated in a single data store. Furthermore, in some embodiments, some or all of data stores 706 and/or 708 are incorporated in admin computing device 702, resource provider system 110, job data consolidation service 704, architecture 106, and/or architecture 108.

In examples, admin computing device 702 (also referred to as “computing device 702”) is any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. In accordance with an embodiment, computing device 702 is associated with an admin user (e.g., an individual admin user (e.g., a developer, a service manager, a service technician, a software engineer, and/or the like), a group of admin users (e.g., a development team, a service team, an engineering team, an account management team, and/or the like), an organization (e.g., a resource provider organization), etc.). In accordance with an embodiment, admin computing device 702 is incorporated within resource provider system 110. Computing device 702 is configured to execute applications, in some embodiments. For instance, in accordance with an embodiment, computing device 702 is configured to execute an application utilized to manage a user account, manage migration between architecture 106 and 108, manage operation of architectures 106 and/or 108, manage deployment of software updates to architectures 106 and/or 108, rollback a change made to architectures 106 and/or 108, obtain data stored in a data store of system 700, generate and store data, and/or perform other operations associated with providing user accounts access to resources of architectures 106 and 108.

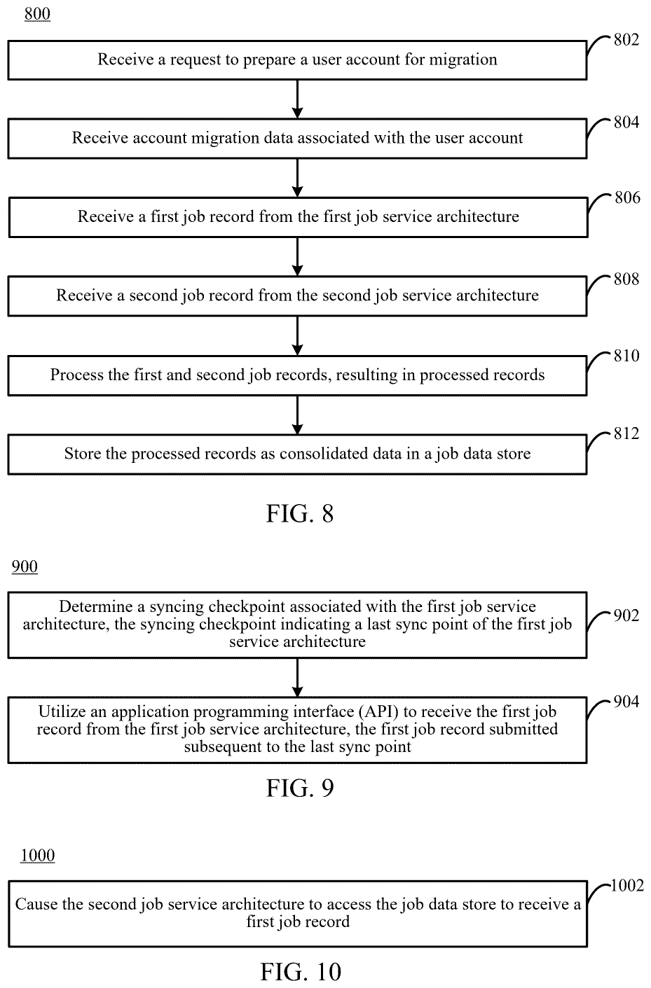

Job data consolidation service 704 is configured to synchronize data from architectures 106 and 108 for a user account into a centralized data store (e.g., data store 708 in FIG. 7). In some embodiments, and as further described with respect to FIGS. 11 and 12, job data consolidation service 704 provides an interface for fulfilling job report requests (e.g., job list requests, list pipelines, aggregated job reports, billing reports, historical pipeline data requests, and/or other requests related to the status of a job). In some embodiments, job data consolidation service 704 is a subcomponent/subservice of job router 104 of FIG. 1. Alternatively, job data consolidation service 704 is a separate service from job router 104. To better understand the operation of job data consolidation service 704, FIG. 7 is described with respect to FIG. 8. FIG. 8 shows a flowchart 800 of a process for preparing a user account for migration and consolidating job data, in accordance with an example embodiment. In accordance with an embodiment, job data consolidation service 704 operates in accordance with one or more steps of flowchart 800. Note not all steps of flowchart 800 need be performed in all embodiments. Further structural and operational embodiments will be apparent to persons skilled in the relevant art(s) based on the following descriptions of FIGS. 7 and 8.

Flowchart 800 begins with step 802. In step 802, a request to prepare a user account for migration is received. For example, consolidation orchestrator 710 receives a request 722 to prepare a user account for migration. In accordance with an embodiment, resource provider system 110 generates request 722 responsive to instructions 718 received from admin computing device 702. For example, an admin user interacts with admin computing device 702 to transmit instructions 718 to resource provider system 110 to migrate one or more user accounts from architecture 106 to architecture 108. In this context, resource provider system 110 updates account migration data 714 with migration status 720. Migration status 720 indicates each of the one or more user accounts are in a “preparing” migration state. In embodiments, request 722 is for a single user account or multiple user accounts. In embodiments, consolidation orchestrator 710 queues and/or pipelines consolidation of data of multiple user accounts at once.

In step 804, account migration data associated with the user account is received. For example, consolidation orchestrator 710 of FIG. 7 obtains account migration data 724 associated with the one or more user accounts stored as account migration data 714 in data store 706. Alternatively, the account migration data is included in request 722. In some embodiments, consolidation orchestrator 710 generates a migration file (not shown in FIG. 7 for brevity) comprising account details and the migration state for each user account. Consolidation orchestrator 710 stores the migration file locally and/or in a data store (e.g., data store 708). In accordance with an embodiment, the migration file includes a timestamp indicating the last time job records for a job service architecture (e.g., architecture 106 or architecture 108) were synchronized. In this context, the initial values of the timestamps are null, empty, zero, or otherwise indicating job records have not been synchronized for the architectures.

In embodiments, consolidation orchestrator 710 provides signal 726 to data synchronizer 712 to cause data synchronizer 712 to perform steps 806-812 of flowchart 800. In embodiments, signal 726 comprises information included in request 722, account migration data 724 and/or one or more migration files generated by consolidation orchestrator 710. In embodiments, data synchronizer 712 generates a worker thread for each user account and/or migration file. The worker thread is configured to perform one or more steps of steps 806-812 with respect to a particular user account and/or migration file. In this context, data synchronizer 712 performs operations with respect to multiple user accounts and/or migration files in parallel. In embodiments, a worker thread performs one or more steps of steps 806-812 periodically (e.g., on a scheduled routine basis, in an ordered routine basis, and/or the like).

In step 806, a first job record is received from the first job service architecture. For example, data synchronizer 712 of FIG. 7 (or a worker thread of a user account) provides a request for job record data 728 (“request 728” herein) to service frontend 116. In accordance with an embodiment, request 728 is a request for all job records of architecture 106 for the user account. Alternatively, request 728 is a request for job records created and/or updated since a timestamp (e.g., a timestamp indicated in a migration file for the user account). In accordance with an embodiment, request 728 includes a submit time filter to cause service frontend 116 to provide job records for jobs submitted after the timestamp. In accordance with an embodiment, request 728 limits the number of records retrieved at a time (e.g., 10 records, 100 records, 200 records, and/or the like) in order to limit the load applied to architecture 106. Responsive to request 728, service frontend 116 obtains records 730 from data store 112. In embodiments, records 730 comprise all of or a portion of records 140 (e.g., a portion of records 140 submitted after a timestamp indicated in request 728). As shown in FIG. 7, service frontend 116 provides records 730 as response 732.

In step 808, a second job record is received from the second job service architecture. For example, data synchronizer 712 of FIG. 7 (or a worker thread of the user account) provides a request for job record data 734 (“request 734” herein) to service frontend 128. In accordance with an embodiment, request 734 is a request for all job records of architecture 108 for the user account. Alternatively, request 734 is a request for job records created and/or updated since a timestamp since job records were last obtained from architecture 108. In accordance with an embodiment, request 734 includes a submit time filter to cause service frontend 128 to provide job records for jobs submitted after the timestamp. In accordance with an embodiment, request 734 limits the number of records retrieved at a time in order to limit the load applied to architecture 106. Responsive to request 734, service frontend 128 obtains records 736 from data store 114. In embodiments, records 736 comprises all or a portion of records 142. As shown in FIG. 7, service frontend 128 provides records 736 as response 738.

In step 810, the first and second job records are processed, resulting in processed records. For example, data synchronizer 712 processes job records included in responses 732 and 738 for storing in data store 708 as part of synchronized job records 716. For instance, in an embodiment, data synchronizer 712 removes excess/empty fields from a job record. In embodiments, data synchronizer 712 processes records from architectures 106 and 108 simultaneously or separately. For instance, in accordance with an embodiment, data synchronizer 712 comprises a worker thread that processes records from architecture 106 and another worker thread that processes records from architecture 108.

In step 812, the processed records are stored in a job data store as consolidated data. For example, data synchronizer 712 stores processed records 740 in data store 708 as synchronized job records 716 (also referred to as “consolidated job data 716”). In accordance with an embodiment, data synchronizer 712 updates the timestamp in the migration file for the user account indicating the time since job records for architecture 106 and/or 108 has been updated.

Once job records are synchronized for architectures 106 and 108 (i.e., no new jobs based on the available checkpoint are recorded), data synchronizer 712 transmits a synchronized update 742 to account migration data 714. Synchronized update 742 causes the user account to be marked as “in sync” in account migration data 714. In this context, the account is ready to have its migration status changed to “enabled”.

By consolidating data between job service architectures, job data consolidation service 704 enables seamless migration of a user account from one architecture to another. For instance, suppose resource provider system 110 in a non-limiting example, is rolling back a feature on architecture 108. In this example, resource provider system 110 prevents new jobs to be scheduled to architecture 108. Since job data is synchronized between architectures 106 and 108, job router 104 of FIG. 1 is able to schedule jobs that reference data in synchronized job records 716 to architecture 106. In this context, architecture 106 is able to fulfill job requests without impacting the user experience of the user account (e.g., input in computing device 178 is unchanged independent of which architecture the job is to be scheduled to). Job data consolidation service 704 provides an interface for fulfilling job report requests (e.g., job list requests, list pipelines, aggregated job reports, billing reports, historical pipeline data requests, and/or other requests related to the status of one or more jobs (or a group of jobs) (e.g., without requiring a request to be routed to a corresponding job service). This prevents downtime for job service systems described herein performing a job for the user account, while allowing an admin user or team to investigate and fix issues encountered with the target architecture and, once the issue is resolved, attempt to migrate the account to the target architecture. In this manner, the user experience is preserved during migration, thereby ensuring business continuity and providing a seamless interface for scheduling jobs to an architecture regardless of migration state.

Furthermore, job data consolidation service 704 employs a unified data store (data store 708) for job records. This reduces the amount of storage space job data consumes, as job data does not need to be replicated across architectures 106 and 108. Instead, job data consolidation service 704 maintains the synchronized job records and each of architectures 106 and 108 are able to access (either directly or through job data consolidation service 704, depending on the embodiment) the synchronized data to perform jobs. Furthermore, once a record is stored in the synchronized job records 716, the corresponding architecture may remove the record from its store (e.g., architecture 106 removes the record from records 140, architecture 108 removes the record from records 142, etc.), thereby freeing storage space within the corresponding architecture.

Embodiments of data synchronizer 712 of FIG. 7 have been described as receiving job records from architectures 106 and 108. In embodiments, data synchronizer 712 operates to receive job records in various ways. For instance, FIG. 9 shows a flowchart 900 of a process for receiving a job record, in accordance with another example embodiment. In accordance with an embodiment, data synchronizer 712 operates in accordance with one or more steps of flowchart 900. Note not all steps of flowchart 900 need be performed in all embodiments. Further structural and operational embodiments will be apparent to persons skilled in the relevant art(s) based on the following description of FIG. 9 with respect to FIG. 7.

Flowchart 900 begins with step 902. In step 902, a syncing checkpoint associated with the first job service architecture is determined, the syncing checkpoint indicating a last sync point of the first job service architecture. For example, data synchronizer 712 of FIG. 7 determines a syncing checkpoint of architecture 106 or 108 for a user account (e.g., based on a migration file of the user account) indicating a last sync point of the corresponding architecture. In this context, the syncing checkpoint indicates the last time the synchronized job records for that architecture was updated.

In step 904, an API is utilized to receive the first job record from the first job service architecture, the first job record submitted subsequent to the last sync point. For example, data synchronizer 712 of FIG. 7 transmits request 728 as an API call to service frontend 116 and receives response 732 as an API response comprising job records 730. In another example, data synchronizer 712 of FIG. 7 transmits request 734 as an API call to service frontend 128 and receives response 738 as an API response comprising job records 736.

Thus, example embodiments of consolidating/synchronizing job records between architectures have been described with respect to FIGS. 7-9. Once job records are synchronized, an architecture is able to access the synchronized job records (e.g., synchronized job records 716). For instance, suppose architecture 108 is performing a job that references data generated by a job performed by architecture 106. In this context, rather than requesting the data from architecture 106, architecture 108 (or a component thereof, e.g., job service 130, compute cluster 134, etc.) accesses synchronized job records 716 (e.g., directly or via job data consolidation service 704). Architecture 108 is caused to access consolidated data in various ways, in embodiments. For instance, FIG. 10 shows a flowchart 1000 of a process for utilizing consolidated data, in accordance with another example embodiment. In accordance with an embodiment, job data consolidation service 704 operates in accordance with the step of flowchart 1000. Note flowchart 1000 need not be performed in all embodiments. Further structural and operational embodiments will be apparent to persons skilled in the relevant art(s) based on the following description of FIG. 10 with respect to FIG. 7.

Flowchart 1000 comprises step 1002. In step 1002, the second job service architecture is caused to access the job data store to receive a first job record. For example, suppose architecture 108 of FIG. 7 is executing a job that references a record of another job (or a record of the executing job). In this context, architecture 108 (or a component thereof, e.g., service frontend 128) accesses synchronized job records 716 to obtain the job record. In some embodiments, architecture 108 (or the component thereof) accesses synchronized job records 716 directly (e.g., by transmitting a request to or searching data store 708) or indirectly (e.g., by transmitting a request to data synchronizer 712). By having a synchronized store for job records across both architectures, jobs executing on either architecture are able to access records without having to utilize compute resources of the architecture to duplicate records across both records each time a job is updated.

In some embodiments, job router 104 routes requests for job reports based on migration status of a user account. Job router 104 is configurable in various ways to fulfill a job report request. For instance, in accordance with an embodiment, job router 104 leverages job consolidation service 704 to fulfill job report requests. In this context, once job data consolidation service has synchronized job records across architectures 106 and 108, it is able to act as a centralized data manager for job data. Systems that utilize job data consolidation service 704 to fulfill job report requests are configured in various ways. For instance, FIG. 11 shows a block diagram of a system 1100 for fulfilling a job report request, in accordance with an example embodiment. As shown in FIG. 11, system 1100 comprises job router 104, resource provider system 110, and service frontend 116, as described with respect to FIG. 1, as well as job data consolidation service 704 and synchronized job records 716, as described with respect to FIG. 7. To better understand the operation of system 1100, FIG. 11 is described with respect to FIG. 12. FIG. 12 shows a flowchart 1200 of a process for fulfilling a job report request, in accordance with an example embodiment. In accordance with an embodiment, job router 104 operates in accordance with one or more steps of flowchart 1200. Note not all steps of flowchart 1200 need be performed in all embodiments. Further structural and operational embodiments will be apparent to persons skilled in the relevant art(s) based on the following descriptions of FIGS. 11 and 12.

Flowchart 1200 begins with step 1202. In step 1202, a job report request is received. For example, job router 104 receives a job report request 1102. In embodiments, job report request 1102 is received from gateway 102 (e.g., responsive to user input from user computing device 178, application input from user computing device 178) or a service frontend of architectures 106 and/or 108 (e.g., on behalf of a corresponding job service). Job report request 1102 comprises instructions to obtain a status of one or more jobs, instructions to obtain a status of all jobs executing on (or executed by) architecture 106 and/or 108, instructions to obtain a status of all jobs submitted within a period of time, jobs associated with a user account, and/or the like.

In step 1204, a determination of whether or not a user account has a migration status is determined. For example, job router 104 receives configuration data 1104 from resource provider system 110 (e.g., in a similar manner as described with respect to configuration data 152) and determines whether or not the user account has a migration status. If the user account has a migration status, flowchart 1200 continues to step 1206. Otherwise, flowchart 1200 continues to step 1210.

In step 1206, the job data consolidation service is caused to retrieve the consolidated data from the job data store. For example, if a migration status exists for the user account (i.e., it is not null, zero, none, etc.), job router 104 transmits instructions 1106 to cause job data consolidation service 704 to obtain records 1108 and provide response 1110 indicating a status of the one or more jobs status was requested for. In accordance with an embodiment, instructions 1106 comprises a job ID for the jobs a status is to be requested for. Alternatively, instructions 1106 indicate a submission time that job status is to be requested for. Alternatively, instructions 1106 comprises instructions to obtain all job statuses. Job data consolidation service 704, in an embodiment, searches synchronized job records 716 for records 1108 satisfying instructions 1106 and provides the obtained records in response 1110.

In step 1208, the consolidated data is caused to be provided as a response to the job report request. For example, job router 104 provides consolidated data as a response 1116 to request 1102. In accordance with an embodiment, response 1116 comprises a status for each job included in response 1110. Alternatively, responses for each job are provided individually or in sub-groups (e.g., active jobs, completed jobs, stalled jobs, and/or the like).

In step 1210, the job report request is transmitted to the first job service architecture. For example, if there is no migration state for the user account, or the account is still in the “preparing” mode, job router 104 transmits a request 1112 for a status of jobs indicated in request 1102 to service frontend 116. Request 1112 comprises similar information as described with respect to instructions 1106. In accordance with an embodiment, request 1112 is a rerouted version of request 1102.

In step 1212, the job status data is caused to be provided as a response to the job report request. For example, job router 104 provides job status data as a response 1116 to request 102. In accordance with an embodiment, response 116 comprises a status for each job included in response 1114. Alternatively, responses for each job are provided individually or in sub-groups.

Thus, example embodiments for fulfilling a job report request have been described with respect to FIGS. 11 and 12. Once job records are synchronized between architectures (e.g., as described with respect to FIGS. 7 and 8), job data consolidation service 704 acts as a centralized hub for job data of a user account. Thus, scalability of migration of user accounts between architectures is improved, as listing and aggregated report requests are pipelined to job data consolidation service 704, rather than utilizing the service frontend and job service of the corresponding architecture. For instance, in some scenarios, a user utilizes API calls with various (e.g., complex) data filters and/or queries. If these calls were routed to the job service of the architecture, they can cause a (e.g., heavy) load on the job service and database, thereby impacting job submission and scheduling. Instead, embodiments such as system 1100 of FIG. 11 leverage job data consolidation service 704 to respond to these calls, reducing the impact on the job submission and scheduling path.

### IV. Example Computer System Implementation

Embodiments of dynamic job routing and data consolidation described herein are implemented in hardware, or hardware combined with one or both of software and/or firmware. For example, gateway 102, job router 104, resource provider system 110, service frontend 116, job service 118, resource manager 120, application manager 122, containers 124, service frontend 128, job service 130, cluster service 132, resource manager 136, node managers 138, job data consolidation service 704, and/or the components described therein, and/or the steps of flowcharts 200, 400, 500, 600, 800, 900, 1000, and/or 1200 and/or the steps of sequence diagrams 300 and/or 350, are each implemented as computer program code/instructions configured to be executed in one or more processors and stored in a computer readable storage medium. Alternatively, gateway 102, job router 104, resource provider system 110, service frontend 116, job service 118, resource manager 120, application manager 122, containers 124, service frontend 128, job service 130, cluster service 132, resource manager 136, node managers 138, job data consolidation service 704, and/or the components described therein, and/or the steps of flowcharts 200, 400, 500, 600, 800, 900, 1000, and/or 1200 and/or the steps of sequence diagrams 300 and/or 350, are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

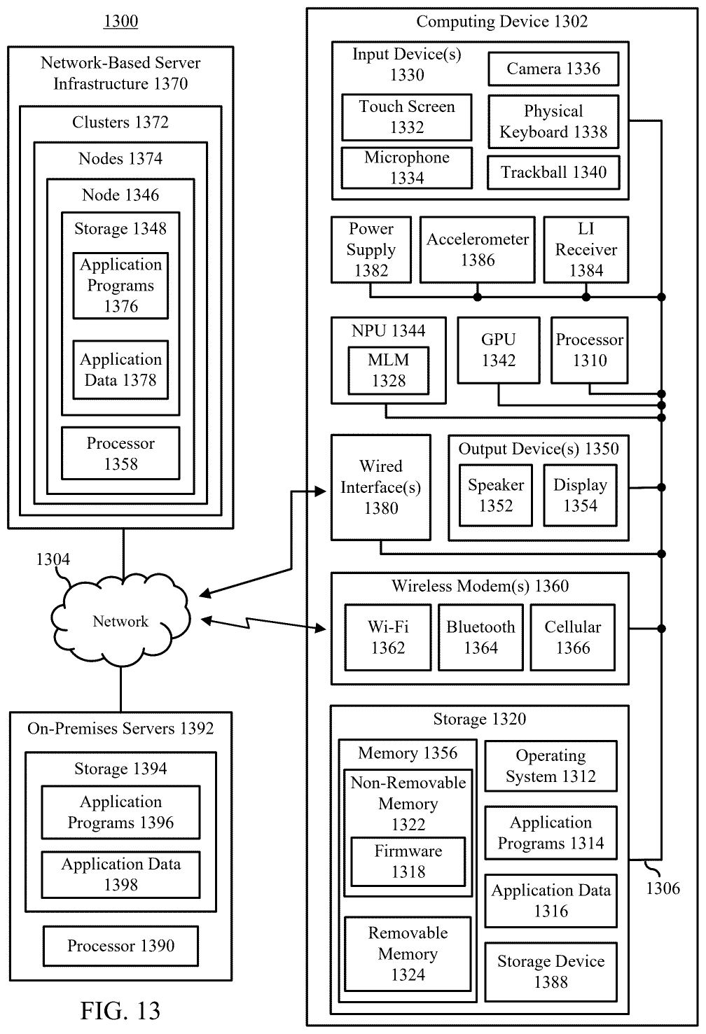

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 13. FIG. 13 shows a block diagram of an exemplary computing environment 1300 that includes a computing device 1302. Computing device 1302 is an example of architecture 106, architecture 108, resource provider system 110, user computing device 178, and/or computing device 702, which each include one or more of the components of computing device 1302. In some embodiments, computing device 1302 is communicatively coupled with devices (not shown in FIG. 13) external to computing environment 1300 via network 1304. Network 1304 comprises one or more networks such as local area networks (LANs), wide area networks (WANs), enterprise networks, the Internet, etc. In examples, network 1304 includes one or more wired and/or wireless portions. In some examples, network 1304 additionally or alternatively includes a cellular network for cellular communications. Computing device 1302 is described in detail as follows.

Computing device 1302 can be any of a variety of types of computing devices. Examples of computing device 1302 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 1302 is a stationary computing device such as a desktop computer, a personal computer (PC), a stationary server device, a minicomputer, a mainframe, a supercomputer, etc.

As shown in FIG. 13, computing device 1302 includes a variety of hardware and software components, including a processor 1310, a storage 1320, a graphics processing unit (GPU) 1342, a neural processing unit (NPU) 1344, one or more input devices 1330, one or more output devices 1350, one or more wireless modems 1360, one or more wired interfaces 1380, a power supply 1382, a location information (LI) receiver 1384, and an accelerometer 1386. Storage 1320 includes memory 1356, which includes non-removable memory 1322 and removable memory 1324, and a storage device 1388. Storage 1320 also stores an operating system 1312, application programs 1314, and application data 1316. Wireless modem(s) 1360 include a Wi-Fi modem 1362, a Bluetooth modem 1364, and a cellular modem 1366. Output device(s) 1350 includes a speaker 1352 and a display 1354. Input device(s) 1330 includes a touch screen 1332, a microphone 1334, a camera 1336, a physical keyboard 1338, and a trackball 1340. Not all components of computing device 1302 shown in FIG. 13 are present in all embodiments, additional components not shown may be present, and in a particular embodiment any combination of the components are present. In examples, components of computing device 1302 are mounted to a circuit card (e.g., a motherboard) of computing device 1302, integrated in a housing of computing device 1302, or otherwise included in computing device 1302. The components of computing device 1302 are described as follows.

In embodiments, a single processor 1310 (e.g., central processing unit (CPU), microcontroller, a microprocessor, signal processor, ASIC (application specific integrated circuit), and/or other physical hardware processor circuit) or multiple processors 1310 are present in computing device 1302 for performing such tasks as program execution, signal coding, data processing, input/output processing, power control, and/or other functions. In examples, processor 1310 is a single-core or multi-core processor, and each processor core is single-threaded or multithreaded (to provide multiple threads of execution concurrently). Processor 1310 is configured to execute program code stored in a computer readable medium, such as program code of operating system 1312 and application programs 1314 stored in storage 1320. The program code is structured to cause processor 1310 to perform operations, including the processes/methods disclosed herein. Operating system 1312 controls the allocation and usage of the components of computing device 1302 and provides support for one or more application programs 1314 (also referred to as “applications” or “apps”). In examples, application programs 1314 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 1310 includes one or more general processors (e.g., CPUs) configured with or coupled to one or more hardware accelerators, such as one or more NPUs 1344 and/or one or more GPUs 1342.

Any component in computing device 1302 can communicate with any other component according to function, although not all connections are shown for case of illustration. For instance, as shown in FIG. 13, bus 1306 is a multiple signal line communication medium (e.g., conductive traces in silicon, metal traces along a motherboard, wires, etc.) present to communicatively couple processor 1310 to various other components of computing device 1302, although in other embodiments, an alternative bus, further buses, and/or one or more individual signal lines is/are present to communicatively couple components. Bus 1306 represents one or more of any of several types of bus structures, including a memory bus or memory controller, a peripheral bus, an accelerated graphics port, and a processor or local bus using any of a variety of bus architectures.

Storage 1320 is physical storage that includes one or both of memory 1356 and storage device 1388, which store operating system 1312, application programs 1314, and application data 1316 according to any distribution. Non-removable memory 1322 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 1322 includes main memory and is separate from or fabricated in a same integrated circuit as processor 1310. As shown in FIG. 13, non-removable memory 1322 stores firmware 1318 that is present to provide low-level control of hardware. Examples of firmware 1318 include BIOS (Basic Input/Output System, such as on personal computers) and boot firmware (e.g., on smart phones). In examples, removable memory 1324 is inserted into a receptacle of or is otherwise coupled to computing device 1302 and can be removed by a user from computing device 1302. Removable memory 1324 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 1388 are present that are internal and/or external to a housing of computing device 1302 and are or are not removable. Examples of storage device 1388 include a hard disk drive, a SSD, a thumb drive (e.g., a USB (Universal Serial Bus) flash drive), or other physical storage device.

One or more programs are stored in storage 1320. Such programs include operating system 1312, one or more application programs 1314, and other program modules and program data. Examples of such application programs include computer program logic (e.g., computer program code/instructions) for implementing gateway 102, job router 104, resource provider system 110, service frontend 116, job service 118, resource manager 120, application manager 122, containers 124, service frontend 128, job service 130, cluster service 132, resource manager 136, node managers 138, job data consolidation service 704, and/or the components described therein, and/or the steps of flowcharts 200, 400, 500, 600, 800, 900, 1000, and/or 1200 and/or the steps of sequence diagrams 300 and/or 350.

Storage 1320 also stores data used and/or generated by operating system 1312 and application programs 1314 as application data 1316. Examples of application data 1316 include web pages, text, images, tables, sound files, video data, and other data. In examples, application data 1316 is sent to and/or received from one or more network servers or other devices via one or more wired or wireless networks. Storage 1320 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 1302 through one or more input devices 1330 and receives information from computing device 1302 through one or more output devices 1350. Input device(s) 1330 includes one or more of touch screen 1332, microphone 1334, camera 1336, physical keyboard 1338 and/or trackball 1340 and output device(s) 1350 includes one or more of speaker 1352 and display 1354. Each of input device(s) 1330 and output device(s) 1350 are integral to computing device 1302 (e.g., built into a housing of computing device 1302) or are external to computing device 1302 (e.g., communicatively coupled wired or wirelessly to computing device 1302 via wired interface(s) 1380 and/or wireless modem(s) 1360). Further input devices 1330 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1354 displays information, as well as operating as touch screen 1332 by receiving user commands and/or other information (e.g., by touch, finger gestures, virtual keyboard, etc.) as a user interface. Any number of each type of input device(s) 1330 and output device(s) 1350 are present, including multiple microphones 1334, multiple cameras 1336, multiple speakers 1352, and/or multiple displays 1354.

In embodiments where GPU 1342 is present, GPU 1342 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 1342 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 1344 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 1328. In an example, NPU 1344 is configured for a data-driven parallel computing and is highly efficient at processing massive multimedia data such as videos and images and processing data for neural networks. NPU 1344 is configured for efficient handling of AI-related tasks, such as speech recognition, background blurring in video calls, photo or video editing processes like object detection, etc.

In embodiments disclosed herein that implement ML models, NPU 1344 can be utilized to execute such ML models, of which MLM 1328 is an example. For instance, where applicable, MLM 1328 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 1344 is used to train MLM 1328. To train MLM 1328, training data is that includes input features (attributes) and their corresponding output labels/target values (e.g., for supervised learning) is collected. A training algorithm is a computational procedure that is used so that MLM 1328 learns from the training data. Parameters/weights are internal settings of MLM 1328 that are adjusted during training by the training algorithm to reduce a difference between predictions by MLM 1328 and actual outcomes (e.g., output labels). In some examples, MLM 1328 is set with initial values for the parameters/weights. A loss function measures a dissimilarity between predictions by MLM 1328 and the target values, and the parameters/weights of MLM 1328 are adjusted to minimize the loss function. The parameters/weights are iteratively adjusted by an optimization technique, such as gradient descent. In this manner, MLM 1328 is generated through training by NPU 1344 to be used to generate inferences based on received input feature sets for particular applications. MLM 1328 is generated as a computer program or other type of algorithm configured to generate an output (e.g., a classification, a prediction/inference) based on received input features, and is stored in the form of a file or other data structure.

In examples, such training of MLM 1328 by NPU 1344 is supervised or unsupervised. According to supervised learning, input objects (e.g., a vector of predictor variables) and a desired output value (e.g., a human-labeled supervisory signal) train MLM 1328. The training data is processed, building a function that maps new data on expected output values. Example algorithms usable by NPU 1344 to perform supervised training of MLM 1328 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 1328 is an LLM, MLM 1328 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 1328 is trained to learn patterns from unlabeled data. For instance, in embodiments where MLM 1328 implements unsupervised learning techniques, MLM 1328 identifies one or more classifications or clusters to which an input belongs. During a training phase of MLM 1328 according to unsupervised learning, MLM 1328 tries to mimic the provided training data and uses the error in its mimicked output to correct itself (i.e., correct weights and biases). In further examples, NPU 1344 perform unsupervised training of MLM 1328 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 1344 need not necessarily be present in all ML model embodiments. In embodiments where ML models are present, any one or more of processor 1310, GPU 1342, and/or NPU 1344 can be present to train and/or execute MLM 1328.

One or more wireless modems 1360 can be coupled to antenna(s) (not shown) of computing device 1302 and can support two-way communications between processor 1310 and devices external to computing device 1302 through network 1304, as would be understood to persons skilled in the relevant art(s). Wireless modem 1360 is shown generically and can include a cellular modem 1366 for communicating with one or more cellular networks, such as a GSM network for data and voice communications within a single cellular network, between cellular networks, or between the mobile device and a public switched telephone network (PSTN). In examples, wireless modem 1360 also or alternatively includes other radio-based modem types, such as a Bluetooth modem 1364 (also referred to as a “Bluetooth device”) and/or Wi-Fi modem 1362 (also referred to as an “wireless adaptor”). Wi-Fi modem 1362 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1364 is configured to communicate with another Bluetooth-capable device according to the Bluetooth short-range wireless technology standard(s) such as IEEE 802.15.1 and/or managed by the Bluetooth Special Interest Group (SIG).

Computing device 1302 can further include power supply 1382, LI receiver 1384, accelerometer 1386, and/or one or more wired interfaces 1380. Example wired interfaces 1380 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 1380 of computing device 1302 provide for wired connections between computing device 1302 and network 1304, or between computing device 1302 and one or more devices/peripherals when such devices/peripherals are external to computing device 1302 (e.g., a pointing device, display 1354, speaker 1352, camera 1336, physical keyboard 1338, etc.). Power supply 1382 is configured to supply power to each of the components of computing device 1302 and receives power from a battery internal to computing device 1302, and/or from a power cord plugged into a power port of computing device 1302 (e.g., a USB port, an A/C power port). LI receiver 1384 is useable for location determination of computing device 1302 and in examples includes a satellite navigation receiver such as a Global Positioning System (GPS) receiver and/or includes other type of location determiner configured to determine location of computing device 1302 based on received information (e.g., using cell tower triangulation, etc.). Accelerometer 1386, when present, is configured to determine an orientation of computing device 1302.

Note that the illustrated components of computing device 1302 are not required or all-inclusive, and fewer or greater numbers of components can be present as would be recognized by one skilled in the art. In examples, computing device 1302 includes one or more of a gyroscope, barometer, proximity sensor, ambient light sensor, digital compass, etc. In an example, processor 1310 and memory 1356 are co-located in a same semiconductor device package, such as being included together in an integrated circuit chip, FPGA, or system-on-chip (SOC), optionally along with further components of computing device 1302.

In embodiments, computing device 1302 is configured to implement any of the above-described features of flowcharts herein. Computer program logic for performing any of the operations, steps, and/or functions described herein is stored in storage 1320 and executed by processor 1310.

In some embodiments, server infrastructure 1370 is present in computing environment 1300 and is communicatively coupled with computing device 1302 via network 1304. Server infrastructure 1370, when present, is a network-accessible server set (e.g., a cloud-based environment or platform). As shown in FIG. 13, server infrastructure 1370 includes clusters 1372. Each of clusters 1372 comprises a group of one or more compute nodes and/or a group of one or more storage nodes. For example, as shown in FIG. 13, cluster 1372 includes nodes 1374. Each of nodes 1374 are accessible via network 1304 (e.g., in a “cloud-based” embodiment) to build, deploy, and manage applications and services. In examples, any of nodes 1374 is a storage node that comprises a plurality of physical storage disks, SSDs, and/or other physical storage devices that are accessible via network 1304 and are configured to store data associated with the applications and services managed by nodes 1374.

Each of nodes 1374, as a compute node, comprises one or more server computers, server systems, and/or computing devices. For instance, a node 1374 in accordance with an embodiment includes one or more of the components of computing device 1302 disclosed herein. Each of nodes 1374 is configured to execute one or more software applications (or “applications”) and/or services and/or manage hardware resources (e.g., processors, memory, etc.), which are utilized by users (e.g., customers) of the network-accessible server set. In examples, as shown in FIG. 13, nodes 1374 includes a node 1346 that includes storage 1348 and/or one or more of a processor 1358 (e.g., similar to processor 1310, GPU 1342, and/or NPU 1344 of computing device 1302). Storage 1348 stores application programs 1376 and application data 1378. Processor(s) 1358 operate application programs 1376 which access and/or generate related application data 1378. In an implementation, nodes such as node 1346 of nodes 1374 operate or comprise one or more virtual machines, with each virtual machine emulating a system architecture (e.g., an operating system), in an isolated manner, upon which applications such as application programs 1376 are executed.

In embodiments, one or more of clusters 1372 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 1372 are included in a datacenter in a distributed collection of datacenters. In embodiments, exemplary computing environment 1300 comprises part of a cloud-based platform.

In an embodiment, computing device 1302 accesses application programs 1376 for execution in any manner, such as by a client application and/or a browser at computing device 1302.

In an example, for purposes of network (e.g., cloud) backup and data security, computing device 1302 additionally and/or alternatively synchronizes copies of application programs 1314 and/or application data 1316 to be stored at network-based server infrastructure 1370 as application programs 1376 and/or application data 1378. In examples, operating system 1312 and/or application programs 1314 include a file hosting service client configured to synchronize applications and/or data stored in storage 1320 at network-based server infrastructure 1370.

In some embodiments, on-premises servers 1392 are present in computing environment 1300 and are communicatively coupled with computing device 1302 via network 1304. On-premises servers 1392, when present, are hosted within an organization's infrastructure and, in many cases, physically onsite of a facility of that organization. On-premises servers 1392 are controlled, administered, and maintained by IT (Information Technology) personnel of the organization or an IT partner to the organization. Application data 1398 can be shared by on-premises servers 1392 between computing devices of the organization, including computing device 1302 (when part of an organization) through a local network of the organization, and/or through further networks accessible to the organization (including the Internet). Furthermore, in examples, on-premises servers 1392 serve applications such as application programs 1396 to the computing devices of the organization, including computing device 1302. Accordingly, in examples, on-premises servers 1392 include storage 1394 (which includes one or more physical storage devices such as storage disks and/or SSDs) for storage of application programs 1396 and application data 1398 and include a processor 1390 (e.g., similar to processor 1310, GPU 1342, and/or NPU 1344 of computing device 1302) for execution of application programs 1396. In some embodiments, multiple processors 1390 are present for execution of application programs 1396 and/or for other purposes. In further examples, computing device 1302 is configured to synchronize copies of application programs 1314 and/or application data 1316 for backup storage at on-premises servers 1392 as application programs 1396 and/or application data 1398.

Embodiments described herein may be implemented in one or more of computing device 1302, network-based server infrastructure 1370, and on-premises servers 1392. For example, in some embodiments, computing device 1302 is used to implement systems, clients, or devices, or components/subcomponents thereof, disclosed elsewhere herein. In other embodiments, a combination of computing device 1302, network-based server infrastructure 1370, and/or on-premises servers 1392 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1320. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 1314) are stored in storage 1320. Such computer programs can also be received via wired interface(s) 1360 and/or wireless modem(s) 1360 over network 1304. Such computer programs, when executed or loaded by an application, enable computing device 1302 to implement features of embodiments discussed herein. Accordingly, such computer programs represent controllers of the computing device 1302.

Embodiments are also directed to computer program products comprising computer code or instructions stored on any computer-readable medium or computer-readable storage medium. Such computer program products include the physical storage of storage 1320 as well as further physical storage types.

### V. Additional Example Embodiments

A system is described herein. The system comprising a processor and memory. The memory stores program code executable by the processor circuit. The program code comprising a job router that: receives, from a computing device, a first job request associated with a user account; determines a migration status of the user account indicates the user account is migrating from a first job service architecture to a second job service architecture; routes the first job request based on the migration status.

In a further example of the foregoing system, wherein the job router: accesses a job status datastore storing job IDs of existing jobs to determine a mapping of the job ID of the first job to the first job service architecture of the second job service architecture; and routes the first job request based on the determined mapping.

In a further example of the foregoing system, wherein the first job request comprises a job identifier (ID) uniquely identifying the first job.

In a further example of the foregoing system, wherein the first job request comprises a script of code and the first job comprises a step to execute the script of code.

In a further example of the foregoing system, wherein the job router routes the first job to the second job service architecture.

In a further example of the foregoing system, wherein the job router, subsequent to routing the first job request to the second job service architecture: receives a second job request associated with the user account; determines the migration state is disabled; determines the second job request corresponds to a second job; and route the second job request to the first job service architecture.

In a further example of the foregoing system, wherein to determine the migration status, the job router: provides an account status request to a resource provider associated with the first and second job service architectures; responsive to providing the account status request, receives the migration status from the resource provider.

In a further example of the foregoing system, wherein the program code further comprises a job data consolidator that: receives a first job record from the first job service architecture; receives a second job record from the second job service architecture; processes the first and second job records to generate processed records; and stores the processed records as consolidated data in a job data datastore.

In a further example of the foregoing system, wherein to receive the first job record, the job data consolidator generates a first worker thread that: determines a syncing checkpoint associated with the first job service architecture, the syncing checkpoint indicating a last sync point of the first job service architecture; and utilizes an application programming interface (API) to receive the first job record from the first job service architecture, the first job record submitted subsequent to the last sync point.

In a further example of the foregoing system, wherein: the first job record corresponds to a previous job performed by the first job service architecture, the previous job comprising a first operation to modify data; the first job comprises a second operation to modify the data; and the first job causes the second job service architecture to access the job data datastore to receive the first job record.

In a further example of the foregoing system, wherein the job router: responsive to receiving a job report request, causes the job data consolidator to retrieve the consolidated data from the job data datastore; and causes the consolidated data to be provided as a response to the job report request.

In a further example of the foregoing system, further comprising: a cache that stores job identifiers (IDs) of existing jobs; and wherein the first job request comprises a job ID and to cause the job to be scheduled, the job router: fails to find a job ID stored by the distributed cache matching the job ID of the first job request, and routes the first job request to the second job service architecture.

In a further example of the foregoing system, wherein the job router: stores, in the cache, a mapping of the job ID of the job request to the routed job service architecture.

A method for dynamically routing job requests to a first job service architecture or a second job service architecture is described herein. The method comprising: receiving, from a computing device, a first job request associated with a user account; determining a migration status of the user account indicates the user account is migrating from a first job service architecture to a second job service architecture; and routing the first job request based on the migration status.

In a further example of the foregoing method, wherein the method further comprises: accessing a job status datastore storing job IDs of existing jobs to determine a mapping of the job ID of the first job to the first job service architecture of the second job service architecture; and routing the first job request based on the determined mapping.

In a further example of the foregoing method, wherein the first job request comprises a job identifier (ID) uniquely identifying the first job.

In a further example of the foregoing method, wherein the first job request comprises a script of code and the first job comprises a step to execute the script of code.

In a further example of the foregoing method, wherein the first job is routed to the second job service architecture.

In a further example of the foregoing method, wherein the method further comprises, subsequent to routing the first job request to the second job service architecture: receiving a second job request associated with the user account; determining the migration state is disabled; determines the second job request corresponds to a second job; and routing the second job request to the first job service architecture.

In a further example of the foregoing method, wherein said determining the migration status comprises: providing an account status request to a resource provider associated with the first and second job service architectures; responsive to providing the account status request, receiving the migration status from the resource provider.

In a further example of the foregoing method, further comprises: receiving a first job record from the first job service architecture; receiving a second job record from the second job service architecture; processing the first and second job records resulting in processed records; and storing the processed records as consolidated data in a job data datastore.

In a further example of the foregoing method, wherein to receive the first job record, the method further comprises generating a first worker thread that: determines a syncing checkpoint associated with the first job service architecture, the syncing checkpoint indicating a last sync point of the first job service architecture; and utilizes an application programming interface (API) to receive the first job record from the first job service architecture, the first job record submitted subsequent to the last sync point.

In a further example of the foregoing method, wherein: the first job record corresponds to a previous job performed by the first job service architecture, the previous job comprising a first operation to modify data; the first job comprises a second operation to modify the data; and the first job causes the second job service architecture to access the job data datastore to receive the first job record.

In a further example of the foregoing method, wherein the method further comprises: responsive to receiving a job report request, causing the job data consolidator to retrieve the consolidated data from the job data datastore; and causing the consolidated data to be provided as a response to the job report request.

In a further example of the foregoing method, wherein a cache stores job identifiers (IDs) of existing jobs; and the first job request comprises a job ID and to cause the job to be scheduled, method further comprises: failing to find a job ID stored by the distributed cache matching the job ID of the first job request, and routing the first job request to the second job service architecture.

In a further example of the foregoing method, the method further comprises: storing, in the cache, a mapping of the job ID of the job request to the routed job service architecture.

A computer readable storage medium is described herein. The computer readable storage medium comprising programming instructions encoded thereon. The programming instructions structured to cause a processor to perform any of the foregoing methods.

### VIII. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, applications, computing devices, gateways, job routers, job data consolidation services, job service architectures, service frontends, job services, compute infrastructures, resource managers, cluster services, application managers, node managers, containers, and their functions may be caused to be activated for operation/performance thereof based on other operations, functions, actions, and/or the like, including initialization, completion, and/or performance of the operations, functions, actions, and/or the like.

Still further, several example embodiments have been described herein with respect to migrating user accounts between architectures for account migration purposes. However, it is also contemplated herein that some embodiments migrate user accounts for other purposes as well. For instance, in accordance with an embodiment, a user account is migrated from one architecture to another (e.g., temporary) architecture while the first undergoes maintenance or software is debugged. In this context, a resource provider is able to provide a backup (e.g., lightweight) architecture to support (e.g., some or all) user account functions while the primary architecture is being updated or fixed.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A system comprising:
a processor;
a memory that stores program code executable by the processor circuit, the program code comprising:
a job router that:
receives a first job request associated with a user account, the first job request comprising a script of code,
determines a migration status of the user account indicates the user account is migrating from a first job service architecture to a second job service architecture and a migration state is enabled, and
routes the first job request to the second job service architecture, the first job request causing the second job service architecture to schedule a first job, the first job comprising a step to execute the script of code.

2. The system of claim 1, wherein, subsequent to routing the first job request, the job router:
receives a second job request associated with the user account;
determines the migration state is disabled;
determines the second job request corresponds to a second job; and
route the second job request to the first job service architecture.

3. The system of claim 1, wherein to determine the migration status, the job router:
provides an account status request to a resource provider associated with the first and second job service architectures;
responsive to providing the account status request, receives the migration status from the resource provider.

4. The system of claim 1, wherein the program code further comprises a job data consolidator that:
receives a first job record from the first job service architecture;
receives a second job record from the second job service architecture;
processes the first and second job records to generate processed records; and
stores the processed records as consolidated data in a job data datastore.

5. The system of claim 4, wherein to receive the first job record, the job data consolidator generates a first worker thread that:
determines a syncing checkpoint associated with the first job service architecture, the syncing checkpoint indicating a last sync point of the first job service architecture; and
utilizes an application programming interface (API) to receive the first job record from the first job service architecture, the first job record submitted subsequent to the last sync point.

6. The system of claim 4, wherein:
the first job record corresponds to a previous job performed by the first job service architecture, the previous job comprising a first operation to modify data;
the first job comprises a second operation to modify the data; and
the first job causes the second job service architecture to access the job data datastore to receive the first job record.

7. The system of claim 4, wherein the job router:
responsive to receiving a job report request, causes the job data consolidator to retrieve the consolidated data from the job data datastore; and
causes the consolidated data to be provided as a response to the job report request.

8. The system of claim 1, further comprising:
a cache that stores job identifiers (IDs) of existing jobs; and
wherein the first job request comprises a job ID and to cause the job to be scheduled, the job router:
fails to find a job ID stored by the distributed cache matching the job ID of the first job request, and
routes the first job request to the second job service architecture.

9. The system of claim 8, wherein the job router:
stores, in the cache, a mapping of the job ID of the job request to the routed job service architecture.

10. A method for dynamically routing job requests to a first job service architecture or a second job service architecture, the method comprising:
receiving, from a computing device, a first job request associated with a user account;
determining a migration status of the user account indicates the user account is migrating from the first job service architecture to the second job service architecture; and
routing the first job request to the second job service architecture, the first job request causing the second job service architecture to schedule a first job.

11. The method of claim 10, wherein:
the first job request comprises a script of code;
the first job comprises a step to execute the script of code; and
said routing the first job request causes the second job service architecture to perform the step by executing the script of code.

12. The method of claim 10, further comprising:
subsequent to said routing the first job request, receiving a second job request associated with the user account;
determining the migration state is disabled;
determining the second job request corresponds to a second job; and
routing the second job request to the first job service architecture.

13. The method of claim 10, further comprising:
receiving a first job record from the first job service architecture;
receiving a second job record from the second job service architecture;
processing the first and second job records to generate processed records; and
storing the processed records as consolidated data in a job data datastore.

14. The method of claim 13, wherein said receiving the first job record comprises:
utilizing a worker thread to determine a syncing checkpoint associated with the first job service architecture, the syncing checkpoint indicating a last sync point of the first job service architecture; and
utilizing the worker thread to utilize an application programming interface (API) to receive the first job record from the first job service architecture, the first job record submitted subsequent to the last sync point.

15. The method of claim 13, further comprising:
responsive to receiving a job report request, receiving the consolidated data from the job data datastore; and
providing the consolidated data as a response to the job report request.

16. The method of claim 10, further comprising:
searching a cache for a first job identifier (ID) that matches a second job ID of the first job, the cache storing job identifiers (IDs) of existing jobs;
failing to find the first job ID in the distributed cache;
routing the first job request to the second job service architecture; and
storing, in the cache, a mapping of the second job ID to the second job service architecture.

17. A computer readable storage medium having program instructions recorded thereon, the program instructions structured to cause a processor to perform a method comprising:
receiving, from a computing device, a first job request associated with a user account and comprising a first job identifier (ID) of a first job;
determining a migration status of the user account indicates the user account is migrating from the first job service architecture to the second job service architecture;
subsequent to said determining the migration status, accessing a job status datastore storing job IDs of existing jobs to determine a mapping of the first job ID to the first job service architecture or the second job service architecture; and
routing the first job request based on the determined mapping.

18. The computer readable storage medium of claim 17, wherein:
the first job request comprises a script of code;
the first job comprises a step to execute the script of code; and
said routing the first job request causes the corresponding job service architecture to perform the step by executing the script of code.

19. The computer readable storage medium of claim 17, wherein the method further comprises:
receiving a job report request requesting a status of the first job;
transmitting instructions to a job data consolidation service to cause the job data consolidation service to determine the status of the first job; and
subsequent to receiving the status of the first job from the job data consolidation service, providing the status of the first job as a response to the job report request.

20. The computer readable storage medium of claim 17, wherein:
the migration status is enabled;
said routing the first job request comprises routing the first job request to the second job service architecture; and
the method further comprises:
subsequent to said routing the first job request, receiving a second job request associated with the user account and comprising a second job ID of a second job,
determining the migration status of the user account has changed to disabled,
determining the second job ID does not match the first job ID, and
routing the second job request to the first job service architecture.
